(19) United States
(12) Patent Application Publication
(10) Pub. No.: US 2023/0330604 A1
(43) Pub. Date: Oct. 19, 2023

(54) MOLECULARLY POROUS CROSS-LINKED MEMBRANES

(71) Applicant: King Abdullah University of Science and Technology, Thuwal (SA)

(72) Inventors: Suzana PEREIRA NUNES, Thuwal (SA); Nivine M. KHACHAB, Thuwal (SA); Stefan CHISCA, Thuwal (SA); Basem A. MOOSA, Thuwal (SA); Tiefan HUANG, Thuwal (SA)

(21) Appl. No.: 18/026,878

(22) PCT Filed: Sep. 17, 2021
(86) PCT No.: PCT/IB2021/058510

§ 371 Date: Mar. 21, 2023

Related U.S. Application Data
(60) Provisional application No. 63/079,590, filed on Sep. 17, 2020.

(51) Int. Cl. B01D 69/12; B01D 71/56

(52) U.S. Cl. CPC B01D 69/1251; B01D 69/1214; B01D 71/56; B01D 2325/04

(57) ABSTRACT

Molecularly porous cross-linked membranes (MPCMs) are described. For example, MPCMs prepared by interfacial polymerization of a reactive macrocycle monomer with intrinsic microporous structure are provided. Macrocycles with multiple reacting sites for cross-linking provide a hyper-cross-linked network suitable for molecular separations employing polar or apolar solvents including organic solvent nanofiltration (OSN).

### BACKGROUND

Separation, recovery, and disposal of organic solvents are a challenge for the petroleum, chemical, and pharmaceutical industries. Traditional chemical engineering processes, such as distillation, adsorption, and extraction, demand high capital and operating cost, consume large amounts of energy, and impose a heavy environmental footprint. An alternative to these technologies is organic solvent nanofiltration (OSN), which usually requires less energy and is more environmentally friendly. However, similar to other membrane-based processes, nanofiltration is heavily plagued by the trade-off between permeability and selectivity. The effective paths for molecular transport in most membranes are not strictly uniform. The precise tuning of the pore size and size distribution to promote high selectivity control at the nanoscale is still in high demand. New strategies providing permanent and uniform porosity are critical to enabling more effective molecular separations.

Interfacial polymerization has been used for decades for thin-film composite (TFC) membrane fabrication, leading to high permeance. It can generate in situ cross-linked polymer layers with demonstrated stability in water and organic solvents. A major drawback of these composite membranes has been the poor selectivity in the separation of molecules with similar size in the nanofiltration range. New monomeric structures are under investigation to improve the overall performance (permeance and selectivity) of TFC membranes. Related approaches consider the integration of well-defined crystalline microporous materials such as metal-organic frameworks (MOFs) and covalent organic frameworks (COFs) for selective separations.

However, fabricating such crystalline membranes free from defects is difficult. A common and simple strategy is the incorporation of microporous materials as fillers in the polymer matrix, forming mixed-matrix membranes (MMMs). These additives can, in principle, provide intrinsic molecular transport channels to facilitate the solvent permeability. The main drawback of discrete additives embedded within a polymer matrix, however, is poor adhesion and aggregation attributed to formation of nonselective voids that can decrease the separation performance.

Macrocyclic molecules with intrinsic microporosity have been employed as recognition units for selective separation in active layers of nanofiltration and molecularly mixed composite membranes preparation. One approach has been the incorporation of charged macrocycles, such as sufocalix[4]arene into films by ionic interaction with polyelectrolytes or by electron donor-acceptor interaction in polymer networks. Cyclodextrins have been incorporated in different forms for membrane preparation aiming at removal of organic pollutants, for instance blended with film-forming polymers. A more successful approach has been effectively linking macrocycles, such as cyclodextrin, to secure stability and avoid leaching out during operation. They have been fixed, for instance, through host-guest interactions with adamantylamine, used as co-monomer in an interfacial an interfacial polymerization reaction or tethered to plasma modified surfaces. Cyclodextrins have been cross-linked in polymeric backbones for the rapid removal of organic pollutants for use as adsorbents. When targeting membranes for liquid separation stability, high permeance and selectivity are required and integrating functional macrocycles as reactive monomer in interfacial polymerization has been demonstrated as one of the most effective approaches for nanofiltration. Considering the rigid and well-defined hollow cavity of cyclodextrins, the membrane was endowed with fast solvents permeance and shape selectivity for molecules. More recently, Noria, a double cyclic ladder-type oligomer, has been successfully used as a recognition unit in selective nanofiltration membranes. However, covalently bonding a macrocyclic host building block to a polymeric matrix has been limited due to solubility considerations, which drastically affected the overall cross-linking. Moreover, employing macrocycles that could be easily functionalized and scaled up is pivotal for the industrial translations of these membranes.

### SUMMARY

The present disclosure describes fabrication of cross-linked membranes featuring interconnected microporosity (i.e., molecularly porous crosslinked membranes (MPCMs). Reactive macrocycles monomers, such as trianglamines are utilized to provide permanent channels for fast solvent permeance and multiple reacting sites for cross-linking permitting the fabrication of a hyper-cross-linked MPCM. The high degree of crosslinking promotes high stability in harsh organic solvent environments, which is ideal for OSN applications.

In a first aspect, the present disclosure provides a method of fabricating a molecularly porous cross-linked membrane comprising reacting a aqueous phase containing an amine macrocycle and an organic phase containing an acyl chloride to induce interfacial polymerization. The amine macrocycle can be a trianglamine. The acyl chloride can be terephthaloyl chloride. The concentration of terephthaloyl chloride in the organic phase can be 0.0125% w/v to 0.1% w/v. The method can further include inducing interfacial polymerization on a polyacrylonitrile membrane support. The reaction time with for the in situ film formation on the support can be 10 seconds to 10 minutes or 10 seconds to 5 minutes. The membrane can be formed at a free interface of the aqueous and organic phases. The reaction time for forming the free standing membrane at the interface can be equal to or less than 10 minutes. The method can further include depositing the free interface-formed membrane on a silica wafer or alumina support. The concentration of the amine macrocycle in the aqueous phase can be 1-2 wt %.

In a second aspect, the present disclosure describes a polyamide molecularly porous cross-linked membrane comprising a crosslinked network of amine macrocycle monomers. The membrane of the second aspect can be made according to any embodiment of the first aspect, or any combination of embodiments. The amine macrocycle monomers can be trianglamine having the following structure:

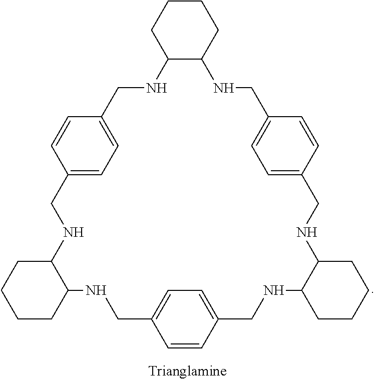 [SMILES: c1cc2ccc1CNC1CCCCC1NCc1ccc(cc1)CNC1CCCCC1NCc1ccc(cc1)CNC1CCCCC1NC2]

Each trianglamine can be covalently linked with four trianglamines. The crosslinks can be formed by reaction of a acyl chloride with an amine groups of the macrocycle ring. The membrane can be less than about 10 nm thick.

In a third aspect, the present disclosure describes a molecularly porous cross-linked membrane comprising:
a crosslinked network of reactive macrocycle monomers having at least two amine groups in the ring, wherein at least two reactive macrocycle monomers are crosslinked to each other via a polyfunctional acyl halide. At least one reactive macrocycle monomer can be a trianglamine of formula I:

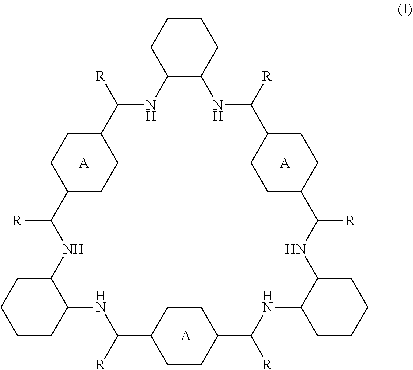

wherein:
each A is an aromatic moiety independently selected from the group consisting of substituted or unsubstituted phenyl, substituted or unsubstituted biphenyl, substituted or unsubstituted triphenyl, substituted or unsubstituted terphenyl, substituted or unsubstituted diphenyl ether, substituted or unsubstituted naphthalene, and substituted or unsubstituted anthracene; and
each R is independently nothing, a hydroxyl, an alkyl, or an alkoxy, with the proviso that when R is nothing the carbon atom to which the R group would be attached is bonded to at least two hydrogens.

Each A can be independently selected from the aromatic moieties of Formula IIA-IID:

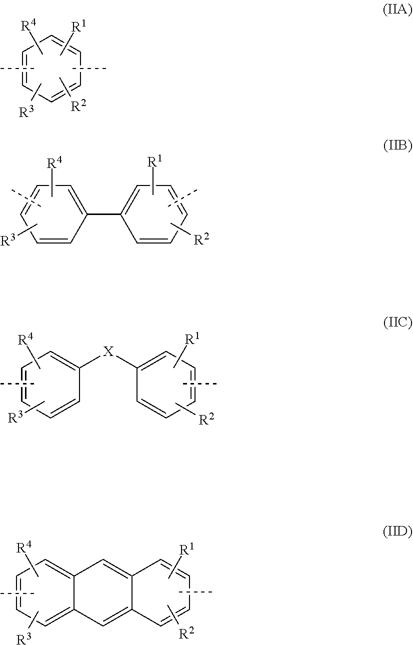

wherein: [symbol]
[symbol] is a point of attachment or nothing;
X is a C, N, S, or O;
R¹, R², R³, and R⁴ are independently a hydrogen, a halogen, a hydroxyl, a linear or branched alkyl, an alkoxy, an aryloxy, or an aralkoxy.

The trianglamine of the third aspect can be a reaction product of a diaminocycloalkyl compound and an aromatic dialdehyde compound. The polyfunctional acyl halide can have at least two acyl halide groups. The polyfunctional acyl halide can be selected from the group consisting of trimesic acid chloride, terephthalic acid chloride, isophthalic acid chloride, biphenyl dicarboxylic acid chloride, and naphthalene dicarboxylic acid dichloride cycloopropane tricarboxylic acid chloride, cyclobutane tetracarboxylic acid chloride, cyclopentane tricarboxylic acid chloride, cyclopentane tetracarboxylic acid chloride, cyclohexane tricarboxylic acid chloride, tetrahydrofuran tetracarboxylic acid chloride, cyclopentane dicarboxylic acid chloride, cyclobutane dicarboxylic acid chloride, cyclohexane dicarboxylic acid chloride, and tetrahydrofuran dicarboxylic acid chloride, or a combination thereof. The percentage of reacted amine groups of the reactive macrocycle is at least 50%. The membrane can include reactive macrocycles having from 2-5 reacted amine groups per macrocycle. The macrocycle content of the membrane can be at least about 60 wt %. The membrane thickness can be within a range of about 3 nm to about 20 nm or less than 10 nm. The membrane pore size can be 6.5 Å or less. The membrane can exhibit charge selectivity. The membrane can reject molecules having a molecular weight equal to or greater than 450 g/mol. The membrane can exhibit chirality selectivity, optionally the membrane rejects dextrorotary molecules.

In a fourth aspect, the present disclosure describes an organic solvent nanofiltration (OSN) membrane comprising: a membrane according to any embodiment of the second aspect, or combination of embodiments of the second aspect, or any embodiment of the third aspect, or any combination of embodiments of the third aspect.

In a firth aspect, the present disclosure describes an organic solvent nanofiltration (OSN) system comprising: a membrane module including a feed side and a permeate side separated by a membrane of the forth aspect.

In a sixth aspect, the present disclosure describes a method of molecular separation comprising contacting a first side of a membrane of the second aspect (i.e., any embodiment or combinations of embodiments of the second aspect) or a membrane of the third aspect (i.e., any embodiment or combinations of embodiments of the third aspect) with a feed stream including one or more solutes in one or more solvents, and collecting a permeate from a second side of the membrane. The one or more solvents can include a polar or apolar organic solvent, including a harsh organic solvent. The polar or apolar organic solvent can be selected from the group consisting of aromatic hydrocarbons, aliphatic hydrocarbons, ketones, glycols, chlorinated solvents, esters, ethers, amines, nitriles, aldehydes, phenols, amides, carboxylic acids, alcohols, furans, lactones, dipolar aprotic solvents, toluene, xylene, benzene, styrene, anisole, chlorobenzene, dichlorobenzene, chloroform, dichloromethane, dichloroethane, methyl acetate, ethyl acetate, isopropyl acetate, butyl acetate, methyl ether ketone (MEK), methyl iso butyl ketone (MIBK), acetone, ethylene glycols, ethanol, methanol, isopropanol, propanol, butanol, hexane, heptane, cyclohexane, dimethoxyethane, methyl tert butyl ether (MTBE), diethyl ether, adiponitrile, N,N-dimethylformamide, dimethylsulfoxide, N,N-dimethylacetamide, dioxane, nitromethane, nitrobenzene, pyridine, carbon disulfide, tetrahydrofuran, methyl-tetrahydrofuran, N-methyl pyrrolidone, N-ethyl pyrrolidone, acetonitrile, and mixtures or blends thereof. Contacting can include microfiltration, nanofiltration, or ultrafiltration, optionally contacting is pressure-driven. The feed stream can be wastewater. The at least one solute can be selected from sugars, salts, amino acids, flavors, genotoxins, colorants, dyes, pigments, catalysts, peptides, antibiotics, proteins, enzymes, and active pharmaceutical ingredients. Contacting can be performed to concentrate at least one solute in the feed stream, purify at least one solute in the feed stream, recover at least one solvent from the feed stream, or a combination thereof.

### BRIEF DESCRIPTION OF THE DRAWINGS

The drawings illustrate generally, by way of example, but not by way of limitation, various embodiments discussed in the present document, in which:

FIG. 1 is a flowchart of a method of making the membranes of the present disclosure, according to one or more embodiments of the invention.

FIGS. 2A-2B are schematics showing fabrication of a molecularly porous crosslinked membrane (MPCM) (as an interfacially polymerized layer) on polyacrylonitrile (PAN) support, according to one or more embodiments of the disclosure: A, Terephthaloyl chloride (TPC) (dots) dissolved in an organic phase, trianglamine (dots) in aqueous phase, reacting to form B, the crosslinked network of MPCM.

FIGS. 3A-3G provides a schematics a method of fabricating a free-standing MPCM nanofilm at a free interface between an organic phase and aqueous phase. A, depicts a support (silica or alumina wafer) at the bottom of petri dish for depositing the formed nanofilm; B, shows trianglamine (dots) in an aqueous phase after addition to the petri dish; C, shows a layer of TPC (dots) dissolved in an organic phase after addition to the petri dish; D, shows instantaneous formation of the free standing film layer at the interface between an aqueous phase containing trianglamine and organic phase containing TPC; E, shows the free-standing film lowered onto the substrate by decreasing the interface via syringe; F, shows a washing step (hexane); G, shows the MPCM nanofilm on the support.

FIG. 4 are images of trianglamine solution before and after adjusting the pH, according to one or more embodiments of the disclosure.

FIG. 5 is ESI-MS of trianglamine solution in water under pH=6.6, according to one or more embodiments of the disclosure.

FIGS. 6A-6I relate to the morphologies of hyper-cross-linked MPCM nanofilms, according to one or more embodiments of the present disclosure. A, depicts a SEM top-view image of a MPCM/PAN composite membrane; B, shows an incipient MPCM nanofilm at the free interface; C, shows an AFM image of the MPCM nanofilm prepared with a reaction time of 10 s on silica wafer; D, shows the height profiles of the MPCM nanofilm of C; E, shows the surface morphology of the MPCM nanofilm of C; F, describes thickness increase with the reaction time; G, is a SEM top-view image of the MPCM nanofilm formed with a reaction time of 10 min on an alumina support, inset: high magnification image of the bare alumina support; H, is a SEM cross-section image of the MPCM nanofilm on an alumina support; I, is a high magnification SEM cross-section image of the MPCM nanofilm covering the alumina support.

FIGS. 7A-7B are SEM images of the PAN support according to one or more embodiments of the present disclosure. A, Surface; B, Cross-section.

FIGS. 8A-8F are SEM images of the surface of MPCM/PAN thin-film composite membranes with 2% trianglamine in the aqueous phase, according to one or more embodiments of the present disclosure. Reaction times: A, 10 min; B, 5 min; C, 2 min; D, 1 min; E, 30 s; F, 10 s.

FIGS. 9A-9F are SEM images of the surface of MPCM/PAN thin-film composite membranes with 1% trianglamine in the aqueous phase, according to one or more embodiments of the present disclosure. Reaction times: A, 10 min; B, 5 min; C, 2 min; D, 1 min; E, 30 s; F, 10 s.

FIGS. 10A-10F are SEM images of the cross-section of MPCM/PAN thin-film composite membranes with 2% trianglamine in the aqueous phase, according to one or more embodiments of the present disclosure. Reaction times: A, 10 min; B, 5 min; C, 2 min; D, 1 min; E, 30 s; F, 10 s.

FIGS. 11A-11F are SEM images of the cross-section of MPCM/PAN thin-film composite membranes with 1% trianglamine in the aqueous phase, according to one or more embodiments of the present disclosure. Reaction times: A, 10 min; B, 5 min; C, 2 min; D, 1 min; E, 30 s; F, 10 s, according to one or more embodiments of the invention.

FIGS. 12A-12F are, from left to right, AFM images, 2D representation, 3D representation and height profile of freestanding MPCM nanofilms, prepared with 2% trianglamine with different reaction times according to one or more embodiments of the present disclosure. Reaction times: A, 10 min B, 5 min, C, 2 min, D, 1 min, E, 30 s, and F, 10 s.

FIGS. 13A-13B are high resolution TEM image of MPCM nanofilms according to one or more embodiments of the present disclosure: A, Cross-section of the polytrianglamine film on PAN support, prepared with 2% trianglamine and 10 min reaction time; B, HR-TEM images of a freestanding polytrianglamine film. The samples were stained with ruthenium oxide.

FIG. 14 is a XRD pattern of a MPCM nanofilm, according to one or more embodiments of the disclosure.

FIG. 15 is a graphical view showing concentration of MPD (squares) and trianglamine (circles) in the organic phase (hexane) of a fabrication method according to one or more embodiments of the present disclosure, monitored at various testing points.

FIGS. 16A-16E describe chemical analyses of a MPCM, according to one or more embodiments of the present disclosure: A, ATR-FTIR spectra of trianglamine, TPC and MPCM; B, XPS survey spectra of PAN support, trianglamine, MPCM/PAN composite membrane, MPCM nanofilm, and PAN support; C, C1 s spectra, and D, N1 s spectra of the MPCM; E, TGA curves of pristine trianglamine and MPCM.

FIG. 17 shows ATR-FTIR spectra of PAN support and MPCM/PAN thin-film composite membrane, according to one or more embodiments of the invention.

FIGS. 18A-18B are XPS characterization to quantify the cross-linking degree of a film, according to one or more embodiments of the present disclosure: A, C1 s and B, N1 s high resolution spectra of trianglamine.

FIGS. 19A-19B are XPS characterization of: A, C1 s and B, N1 s high-resolution spectra of PAN support, according to one or more embodiments of the invention.

FIG. 20 are images of as-prepared MPCM nanofilms, according to one or more embodiments of the invention, in various organic solvents. Top row: immediate immersion; Lower row: immersion after 7 days.

FIG. 21A-21B are images of water droplets on: A, a MPCM/PAN thin-film composite membrane according to one or more embodiments of the present disclosure, and B, a PAN porous support, according to one or more embodiments of the invention.

FIG. 22 is an image of hexane contact angle on MPCM/PAN thin-film composite membrane, according to one or more embodiments of the invention.

FIGS. 23A-23H describe the nanofiltration performance of MPCM nanofilms according to one or more embodiments of the present disclosure: A, Permeance; B, membrane selectivity for various dye molecules by the MPCM prepared with different reaction time; C, UV-vis absorption spectra of the mixed dyes (methyl orange and Nile red) in methanol permeation through a MPCM; D, UV-vis absorption spectra of the rhodamine B base in methanol permeation through the MPCM; E, Permeance of the membranes prepared with a 1 wt % trianglamine (aqueous phase concentration); F, Solvents permeance through the membrane versus the solvent viscosity according to one or more embodiments of the invention; G, shows the chemical structures of the dyes used for the molecular separation experiments; H, summarizes the performance of MPCM, according to one or more embodiments of the present disclosure, with the state-of-the-art OSN membranes.

FIGS. 24A-24D describe separation performance stability of a MPCM/PAN thin-film composite membrane according to one or more embodiments of the present disclosure, before (A and B) and after (C and D) a series of organic solvents filtrations. A and C show rejection of Orange G; and B and D show rejection of Methyl Orange.

FIGS. 25A-25B describe long-term stability of a MPCM/PAN thin-film composite membrane prepared by 2% wt trianglamine of aqueous phase concentration and reaction time of 10 min, according to one or more embodiments of the present disclosure, in A acetone, methanol and toluene; and B, high concentration congo red solution (in methanol) (100 ppm) for more than 48 h.

FIG. 26 describes Toluene permeation vs applied pressure of a MPCM/PAM thin-film composite membrane with reaction time of 10 min, according to one or more embodiments of the present disclosure.

FIG. 27 describes separation performance of MPCM/PAN thin-film composite membrane, according to one or more embodiments of the of the present disclosure, for positive dye methylene blue.

FIGS. 28A-28B describes the simulated properties of trianglamine, according to one or more embodiments of the present disclosure: A, Electrostatic potential (ESP) mapped onto electron density isosurfaces (ρ=0.01) and B a model for the cavity of trianglamine (cavity size value from single crystal structure).

FIG. 29 describes selectivity for various dye molecules. MPCM/PAN thin-film composite membranes prepared with 1% aqueous phase concentration, according to one or more embodiments of the invention.

FIGS. 30A-30B describes performance of MPCM/PAN thin-film composite membranes prepared with different organic phase concentration (1% of aqueous phase concentration and reaction time of 10 s), according to one or more embodiments of the present disclosure: Permeance (A) and selectivity (B) for various dye molecules.

FIGS. 31A-31B illustrate a, Interfacial polymerization between trianglamine fragment and TPC. b, Membrane selectivity for Congo red by the membranes prepared with different reaction time.

FIG. 32 is a graphical view showing pure solvents through MPCM/PAN thin-film composite membranes as a function of their inverse viscosity, according to one or more embodiments of the invention.

FIG. 33 shows chiral selectivity of a MPCM/PAN thin-film composite membrane, according to one or more embodiments of the present disclosure (Left bars: Dextrorotary; Right Bars: Levorotary) by rejection of various optically pure amino acids enantiomers.

FIG. 34 shows chiral selectivity of a MPCM/PAN thin-film composite membrane, according to one or more embodiments of the present disclosure (Left Bars: Dextrorotary; Right Bars: Levorotary) by rejection of various racemic amino acids.

FIGS. 35A-35F depict molecular modeling of a MPCM according to one or more embodiments of the present disclosure: A, Three-dimensional view of an amorphous cell of MPCM with dimension of 30.39 Å×30.39 Å×30.39 Å and the accessible surface at probe radius of 1 Å marked blue. B, Voids distribution with size distinguished by color. C, Simulated pore size distributions of the constructed MPCM. Interconnected and isolated voids space is modeled considering probes of D, 0.85 Å, E, 1.2 Å, and F, 1.55 Å radius, respectively.

FIGS. 36A-36F depict molecular modeling of a membrane prepared from TPC and a trianglamine fragment, with dimension of 34.78 Å×34.78 Å×34.78 Å and accessible surface at probe radius of 1 Å marked blue, according to one or more embodiments of the present disclosure: A, Three-dimensional view of an amorphous cell of the membrane; B, Voids distribution with size distinguished by color; C, Simulated pore size distributions of the membrane. Interconnected and isolated voids space are modeled considering probes of D, 0.85 Å; E, 1.2 Å, and F, 1.55 Å radius, respectively.

### DETAILED DESCRIPTION

### Definitions

As used herein with respect to monomers, the term “reactive macrocycle” refers to any intrinsically porous organic molecule having at least two reactive groups on the macrocyclic ring. The reactive macrocycles of the present disclosure are membrane building units that are capable of being crosslinked into a polymeric network, such as trianglamines, isomers thereof, and derivatives thereof. Trianglamines can be synthesized via a [3+3] thermodynamically controlled imine condensation reaction between equimolar amounts of both aromatic dialdehydes and diamines, with reduction of the resulting trianglimine. Trianglamines with different functionalities, sizes and geometries have been reported. For example, the dialdehyde linker can be varied to alter the size of the intrinsic cavity. Suitable derivatives include trianglamines that have been modified with additional cross-linkable sites and/or functional sites for further reaction, altered charge characteristics and/or for tuning the intrinsic porosity, without elimination of the permanent intrinsic porosity. Other reactive macrocycles useful in the materials and methods of the present disclosure can be selected from trianglimines, isotrianglimines, isotrianglamines, calixsalens, calixsalans, among others. A suitable reactive macrocycle can be selected based on one or more of the following properties: (i) having a cavity size in the range of ions and molecules requiring separations, purification and recovery in the desalination, chemical and pharmaceutical industries; (ii) a channel-like structure (to provide uniform pores in the MPCM, and potentially separate isomeric organic molecules and ions or act as artificial water channels); (iii) being capable of being cross-linked with at least two other reactive macrocycle units; and (vi) chirality. In one or more embodiments, the reactive macrocycle is a trianglamine.

As used herein, the term “membrane” includes freestanding membranes and supported membranes. Freestanding membranes may include thin films, such as nanofilms; whereas supported membranes may include thin film composite membranes. A thin film composite membrane may include a selective layer on a porous support. The selective layer may be formed on a porous support, or it may be formed and subsequently transferred to or deposited on a porous support.

The term “ultrathin” as used to describe layers, films, or membranes refers to a thickness of less than or equal to 10 nm (e.g., within the range of about 2 to less than 10 nm).

A “hyper-crosslinked” when used herein refers to a high degree of crosslinking (i.e., where each macrocyclic unit is crosslinked with at least three other macrocyclic units). Hyper-cross-linking polymerization of the macrocycles makes the resulting film dense and highly stable. Hyper-crosslinked films of the present disclosure have excellent stability in a wide range of solvents

As used herein, “heteroatom” means an atom of any element other than carbon or hydrogen. Examples of heteroatoms include nitrogen, oxygen, boron, phosphorus, and sulfur. Heteroatoms, such as nitrogen, may have hydrogen substituents and/or any permissible substituents of organic compounds described herein which satisfy the valences of the heteroatoms.

The term “aliphatic” when used without the “substituted” modifier signifies that the compound/group so modified is an acyclic or cyclic, but non-aromatic hydrocarbon compound or group. When the term is used with the “substituted” modifier one or more hydrogen atom has been independently replaced by any of the substituents disclosed herein.

As used herein, the term “alkyl” refers to a straight- or branched-chain or cyclic hydrocarbon radical or moiety comprising only carbon and hydrogen atoms, containing no unsaturation, and having 30 or fewer carbon atoms. Alkyls can be substituted or unsubstituted. When the term is used with the “substituted” modifier, one or more hydrogen atoms has been independently replaced by any of the substituents disclosed herein.

The term “cycloalkyl” refers to cyclic alkyls having 3 to 10 carbon atoms in single or multiple cyclic rings, preferably 5 to 6 carbon atoms in a single cyclic ring. Non-limiting examples of suitable alkyl groups include methyl group, ethyl group, propyl group, isopropyl group, cyclopropyl group, butyl group, isobutyl group, sec-butyl group, tert-butyl group, cyclobutyl group, pentyl group, neo-pentyl group, cyclopentyl group, hexyl group, cyclohexyl group, 2-ethylhexyl, cyclohexylmethyl group, heptyl group, octyl group, nonyl group, decyl group, dodecyl group, tridecyl group, tetradcyl group, pentadecyl group, hexadecyl group, heptadecyl group, octadecyl group, nonadecyl group, cyclopentyl group, cyclohexyl group, and the like. Additional examples of cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcaryl, adamantyl, and spiro[4.5]decanyl groups, as well as their homologs, isomers, and the like. Preferably, the alkyl group is selected from methyl group, ethyl group, butyl group, heptyl group, octadecyl group, and the like. Alkyls can be substituted or unsubstituted. When the term is used with the “substituted” modifier, one or more hydrogen atoms has been independently replaced by any of the substituents disclosed herein.

As used herein, the term “heteroalkyl” refers to an alkyl as defined above having at least one carbon atom replaced by a heteroatom. Non-limiting examples of suitable heteroatoms include nitrogen, oxygen, and sulfur. Examples of cycloheteroalkyl groups include, among others, morpholinyl, thiomorpholinyl, pyranyl, imidazolidinyl, imidazolinyl, oxazolidinyl, pyrazolidinyl, pyrazolinyl, pyrrolidinyl, pyrrolinyl, tetrahydrofuranyl, tetrahydrothiophenyl, piperidinyl, piperazinyl, and the like. Heteroalkyls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkenyl” refers to a straight- or branched-chain hydrocarbon radical or moiety comprising only carbon and hydrogen atoms and having at least one carbon-carbon double bond, which can be internal or terminal. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, —CH═CH—C₆H₅, —CH═CH—, —CH═C(CH₃)CH₂—, and —CH═CHCH₂—. The groups, —CH═CHF, —CH═CHCl, —CH═CHBr, and the like. Examples of alkenyl groups include ethenyl, propenyl, butenyl, pentenyl, hexenyl, butadienyl, pentadienyl, hexadienyl groups, and the like. Alkenyls can be substituted or unsubstituted. When the term is used with the “substituted” modifier, one or more hydrogen atoms has been independently replaced by any of the substituents disclosed herein.

As used herein, the term “alkynyl” refers to a straight- or branched-chain hydrocarbon radical or moiety comprising only carbon and hydrogen atoms and having at least one carbon-carbon triple bond, which can be internal or terminal. The groups —C≡CH, —C≡CCH₃, and —CH₂C≡CCH₃, are non-limiting examples of alkynyl groups. Examples of alkynyl groups include ethynyl, propynyl, butynyl, pentynyl, hexynyl, and the like. Alkynes can be substituted or unsubstituted. When the term is used with the “substituted” modifier, one or more hydrogen atoms has been independently replaced by any of the substituents disclosed herein.

As used herein, the term “aryl” refers to a monocyclic or polycyclic aromatic hydrocarbon radical or moiety comprising only carbon and hydrogen atom, wherein the carbon atoms form an aromatic ring structure. If more than one ring is present, the rings may be fused or not fused, or bridged. The term does not preclude the presence of one or more alkyl groups attached to the first aromatic ring or any additional aromatic ring present. The point of attachment can be through an aromatic carbon atom in the ring structure or a carbon atom of an alkyl group attached to the ring structure. Non-limiting examples of aryl groups include phenyl (Ph), toyl, xylyl, methylphenyl, (dimethyl)phenyl, —C₆H₄—CH₂CH₃ (ethylphenyl), naphthyl, and the monovalent group derived from biphenyl. Further examples of aryl groups having only aromatic carbocyclic ring(s) include phenyl, 1-naphthyl (bicyclic), 2-naphthyl (bicyclic), anthracenyl (tricyclic), phenanthrenyl (tricyclic), pentacenyl (pentacyclic), and like groups. Examples of polycyclic ring systems in which at least one aromatic carbocyclic ring is fused to one or more cycloalkyl and/or cycloheteroalkyl rings include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). Other examples of aryl groups include benzodioxanyl, benzodioxolyl, chromanyl, indolinyl groups, and the like. When the term is used with the “substituted” modifier, one or more hydrogen atoms has been independently replaced by any of the substituents disclosed herein.

As used herein, the term “heteroaryl” refers to an aryl having at least one aromatic carbon atom in the ring structure replaced by a heteroatom. Non-limiting examples of suitable heteroatoms include nitrogen, oxygen, and sulfur. The term does not preclude the presence of one or more alkyl groups attached to the first aromatic ring or any additional aromatic ring present. The point of attachment can be through an aromatic carbon atom or aromatic heteroatom in the aromatic ring structure or a carbon atom of an alkyl group attached to the aromatic ring structure. Non-limiting examples of heteroaryl groups include furanyl, benzofuranyl, isobenzylfuranyl, imidazolyl, indolyl, isoindolyl, indazolyl, methylpyridyl, oxazolyl, pyridyl, pyrrolyl, pyrimidyl, pyrazinyl, quinolyl, quinazolyl, quinoxalinyl, thienyl, and triazinyl. Additional examples of heteroaryl groups include, for example, the 5- or 6-membered monocyclic and 5-6 bicyclic ring systems. Examples of such heteroaryl rings include pyrrolyl, furyl, thienyl, pyridyl, pyrimidyl, pyridazinyl, pyrazinyl, triazolyl, tetrazolyl, pyrazolyl, imidazolyl, isothiazolyl, thiazolyl, thiadiazolyl, isoxazolyl, oxazolyl, oxadiazolyl, indolyl, isoindolyl, benzofuryl, benzothienyl, quinolyl, 2-methylquinolyl, isoquinolyl, quinoxalyl, quinazolyl, benzotriazolyl, benzimidazolyl, benzothiazolyl, benzisothiazolyl, benzisoxazolyl, benzoxadiazolyl, benzoxazolyl, cinnolinyl, IH-indazolyl, 2H-indazolyl, indolizinyl, isobenzofuyl, naphthyridinyl, phthalazinyl, pteridinyl, purinyl, oxazolopyridinyl, thiazolopyridinyl, imidazopyridinyl, furopyridinyl, thienopyridinyl, pyridopyrimidinyl, pyridopyrazinyl, pyridopyridazinyl, thienothiazolyl, thienoxazolyl, thienoimidazolyl groups, and the like. Further examples of heteroaryl groups include 4,5,6,7-tetrahydroindolyl, tetrahydroquinolinyl, benzothienopyridinyl, benzofuropyridinyl groups, and the like. Heteroaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “aralkyl” refers to an alkyl having at least one hydrogen atom replaced by an aryl or heteroaryl group. Non-limiting examples of aralkyls are: phenylmethyl (benzyl, Bn) and 2-phenyl-ethyl. The point of attachment can be through a carbon atom of the alkyl group or through an aromatic carbon atom or aromatic heteroatom in the aromatic ring structure of the aryl or heteroaryl group attached to the alkyl group. Aralkyls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkaryl” refers to an aryl or heteroaryl having at least one hydrogen atom replaced by an alkyl or heteroalkyl group. The point of attachment can be an aromatic carbon atom or aromatic heteroatom in the aromatic ring structure or a carbon atom of an alkyl group attached to the ring structure. Alkaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “haloaryl” refers to an aryl or heteroaryl having at least one hydrogen atom replaced by a halogen. The point of attachment can be an aromatic carbon atom or aromatic heteroatom in the aromatic ring structure or a carbon atom of an alkyl group attached to the ring structure. Haloaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkoxy” refers to the group —OR, wherein R is an alkyl or heteroalkyl group. Non-limiting examples of alkoxy groups include: —OCH₃, —OCH₂CH₃, —OCH₂CH₂CH₃, —OCH(CH₃)₂, —OCH(CH₂)₂, —OC₃H₆, —OC₄H₈, —OC₅H₁₀, —OC₆H₁₂, —OCH₂C₃H₆, —OCH₂C₄H₈, —OCH₂C₅H₁₀, —OCH₂C₆H₁₂, and the like. The terms “alkenyloxy”, “alkynyloxy”, “aryloxy”, “aralkoxy”, “heteroaryloxy”, and “acyloxy” refer to the group —OR, wherein R is an alkenyl, alkynyl, aryl, aralkyl, heteroaryl, or acyl group, respectively. Examples include without limitation aryloxy groups such as —O-Ph and aralkoxy groups such as —OCH₂—Ph (—OBn) and —OCH₂CH₂—Ph. Alkoxys, alkenyloxys, alkynyloxys, aryloxys, aralkoxys, heteroaryloxys, and acyloxys can each be substituted or unsubstituted. When those terms are used with the “substituted” modifier, one or more hydrogen atoms has been independently replaced by any of the substituents disclosed herein, or a substituent is bonded to a heteroatom, or both.

As used herein, the term “acyl” refers to the group —C(O)R, wherein R is a hydrogen, alkyl, aryl, aralkyl, or heteroaryl group. Non-limiting examples of acyl groups include: —CHO, —C(O)CH₃ (acetyl (Ac)), —C(O)CH₂CH₃, —C(O)CH₂CH₂CH₃, —C(O)CH(CH₃)₂, —C(O)CH(CH₂)₂, —C(O)C₆H₅, —C(O)C₆H₄—CH₃, —C(O)CH₂C₆H₅, and —C(O)(imidazolyl). The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

As used herein, “amine” and “amino” (and its protonated form) refer to both unsubstituted and substituted amines, e.g., a moiety that can be represented by the general formula NRR′R″, represented by the structure:

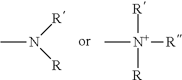

wherein R, R′, and R″ each independently represent a hydrogen, a heteroatom, an alkyl, a heteroalkyl, an alkenyl, —(CH₂)ₘ—Rc or R and R′ taken together with the N atom to which they are attached complete a heterocycle having from 4 to 8 atoms in the ring structure; Rc represents an aryl, a cycloalkyl, a cycloalkenyl, a heterocycle or a polycycle; and m is zero or an integer in the range of 1 to 8, and substituted versions thereof.

The term “alkylamino” when used without the “substituted” modifier refers to the group —NHR, in which R is an alkyl, as that term is defined above. Non-limiting examples of alkylamino groups include: —NHCH₃ and —NHCH₂CH₃. The term “dialkylamino” when used without the “substituted” modifier refers to the group —NRR′, in which R and R′ can be the same or different alkyl groups, or R and R′ can be taken together to represent an alkanediyl. Non-limiting examples of dialkylamino groups include: —N(CH₃)₂, —N(CH₃)(CH₂CH₃), and N-pyrrolidinyl. The terms “alkoxyamino”, “alkenylamino”, “alkynylamino”, “arylamino”, “aralkylamino”, “heteroarylamino”, and “alkylsulfonylamino” when used without the “substituted” modifier, refers to groups, defined as —NHR, in which R is alkoxy, alkenyl, alkynyl, aryl, aralkyl, heteroaryl, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above. When any of these terms is used with the “substituted” modifier one or more hydrogen atom has been independently replaced by —OH, —F, —C₁, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The groups —NHC(O)OCH₃ and —NHC(O)NHCH₃ are non-limiting examples of substituted amido groups.

As used herein, the terms “halide,” “halo,” and “halogen” refer to —F, —Cl, —Br, or —I.

As used herein, the term “substituent” and “substituted” refers to all permissible substituents of the compounds described herein. In the broadest sense, the permissible substituents include acyclic and cyclic, branched and unbranched, carbocyclic and heterocyclic, aromatic and nonaromatic substituents of organic compounds. Examples of substituents include, without limitation, nothing, alkyl, substituted alkyl, cycloalkyl, substituted cycloalkyl, heteroalkyl, substituted heteroalkyl, alkenyl, substituted alkenyl, alkynyl, substituted alkynyl, aryl, substituted aryl, heteroaryl, substituted heteroaryl, aralkyl, substituted aralkyl, alkaryl, substituted alkaryl, haloaryl, substituted haloaryl, alkoxy, substituted alkoxy, alkenyloxy, substituted alkenyloxy, alkynyloxy, substituted alkynyloxy, aryloxy, substituted aryloxy, aralkoxy, substituted aralkoxy, heteroaryloxy, substituted heteroaryloxy, acyloxy, substituted acyloxy, acyl, substituted acyl, halo (—F, —Cl, —Br, —I, etc.), hydrogen (—H), carboxyl (—COOH), hydroxy (—OH), oxo (═O), hydroxyamino (—NHOH), nitro (—NO₂), cyano (—CN), isocyanate (—N═C═O), azido (—N₃), phosphate (e.g., —OP(O)(OH)₂, —OP(O)(OH)O—, deprotonated forms thereof, etc.), mercapto (—SH), thio (═S), thioether (═S—), sulfonamido (—NHS(O)₂—), sulfonyl (—S(O)₂—), sulfinyl (—S(O)₂—), any combinations thereof, and the like.

Additional examples of substituents include, but are not limited to, —NC, —S(R⁰)₂⁺, —N(R⁰)₃⁺, —SO₃H, —SO₂R⁰, —SO₃R⁰, —SO₂NHR⁰, —SO₂N(R), —COR⁰, —COOR⁰, —CONHR⁰, CON(R)₂, C₁₋₄₀ haloalkyl groups, C₆₋₁₄ aryl groups, and 5-14 membered electron-poor heteroaryl groups; where R⁰ is a C₁₋₂₀ alkyl group, a C₂₋₂₀ alkenyl group, a C₂₋₂₀ alkynyl group, a C₁₋₂₀ haloalkyl group, a C₁₋₂₀ alkoxy group, a C₆₋₁₄ aryl group, a C₃₋₁₄ cycloalkyl group, a 3-14 membered cycloheteroalkyl group, and a 5-14 membered heteroaryl group, each of which can be optionally substituted as described herein. Additional examples of substituents include, but are not limited to, —OR, —NH₂, —NHR⁰, —N(R⁰)₂, and 5-14 membered electron-rich heteroaryl groups, where R⁰ is a C₁₋₂₀ alkyl group, a C₂₋₂₀ alkenyl group, a C₂₋₂₀ alkynyl group, a C₆₋₁₄ aryl group, or a C₃₋₁₄ cycloalkyl group.

The present disclosure describes molecularly porous cross-linked membranes (MPCM) including crosslinked polymeric networks of reactive macrocycle monomers, such as trianglamine.

A MPCM of the present disclosure can be characterized by thickness. For example, in one or more embodiments, the MPCM is an ultrathin membrane. Ultrathin membranes can be advantageous for highly selective organic solvent nanofiltration operations, whereby the short transport path provides ultrahigh permeance.

A MPCM of the present disclosure can be characterized by the degree of crosslinking. For example, a MPCM can be hyper-crosslinked. The MPCM can be hyper-crosslinked and ultrathin. The combination of these features can confer a film with interconnected microporosity and/or isoporosity.

A MPCM of the present disclosure exhibits superior separation performance due to their high permeability and sharp selectivity. In some embodiments, the MPCM also exhibits high stability in a wide range of organic solvents, including harsh organic solvents. In addition, the MPCM may be prepared according to methods which are easily scalable for direct industrial production using current membrane production technologies.

The use of trianglamine as a monomer for fabricating a MPCM by interfacial polymerization provides numerous advantages over conventional membrane forming materials and approaches. For example, diffusion of the trianglamine to the reaction zone proceeds more slowly during interfacial polymerization due to the high molecular weight, ionized structure, and low solubility of trianglamine, at least in comparison to other commonly used monomers (e.g., m-phenylenediamine), can yield ultrathin layers with a high content of embedded trianglamine. The intrinsic microporous structure of trianglamine provides permanent interconnected channels for fast solvent permeance. Furthermore, a trianglamine can possess multiple reacting sites for crosslinking and thereby provide a hyper-crosslinked molecularly porous membrane. A high degree of crosslinking imparts high stability in harsh organic solvent environments. Tunability of trianglamine units can be exploited to broaden the scope and performance of the MPCM. For example, the electrostatic property of the cavity, molecular shape, and charge selectivity can be tuned according to methods known to the skilled artisan. Methods demonstrated in the present disclosure with trianglamine can be readily extended to other macrocycles.

A MPCM of the present disclosure can include a network of macrocycles formed by reaction with a crosslinker. In one or more embodiments, the macrocycle includes one or more amine groups in the ring and the crosslinker can be selected from chemical groups that will form chemical bonds with amines. These include isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, and fluorophenyl esters. In one or more embodiments, the crosslinker is an acyl halide. In some cases, the acyl halide crosslinker is a polyfunctional acyl halide having at least two acyl halide (also known as an acid halide) groups. The acyl halide group can be derived from a carboxylic acid group by replacing a hydroxyl group with a halide group. The halide may be selected from fluorine, chlorine, bromine or iodine. The monomer can have acyl halide groups directly attached to an aromatic ring. Typically the aromatic ring is an aromatic ring system comprising less than three aromatic rings. In particular the aromatic ring is phenyl, biphenyl, naphthyl, preferably phenyl. Thus, the acyl halide monomer can be selected from acyl halides based on aromatic polycarboxylic acids, e.g. phthalic acid, isophthalic acid (meta-phthalic acid), terephthalic acid (para-phthalic acid), such as phthaloyl chloride (1,2-benzenedicarbonyl chloride), isophthaloyl chloride (1,3-benzenedicarbonyl chloride), terephthaloyl chloride (TCL, 1,4-benzenedicarbonyl chloride), and trimesoyl chloride (TMC, 1,3,5-benzene-tri-carbonyl-trichloride).

A single crosslink may be formed when each of at least two acyl halide groups which are attached to a polyfunctional acyl halide compound reacts with two reactive macrocycles having at least one amine reactive groups. The reaction may form at least two amide covalent bonds linking at least one reactive macrocycle to at least one other reactive macrocycle, with the polyfunctional acyl halide compound serving as the bridge connecting the at least two reactive macrocycles. A crosslinked polymeric network of polyamide macrocycles may include a plurality of these crosslinks.

The MPCM of the present disclosure can be fabricated using interfacial polymerization as a freestanding membrane or a supported membrane (e.g., as a thin film composite membrane). For example, a reactive macrocycle and crosslinker can each be dissolved in immiscible solutions. A water-soluble reactive macrocycle, such as a trianglamine, can be dissolved in an aqueous phase and a suitable crosslinker will be dissolvable in a water-immiscible solvent to form an organic phase.

In the case of a supported MPCM membrane, a support (e.g., polyacrylonitrile, PSF, polyethersulfone (PES), etc.) is first soaked with an aqueous solution of the reactive macrocycle and in a subsequent step, contacted with an acyl halide solution. These monomers react at the organic/aqueous interface. The self-inhibiting nature and limited supply of the reactants through the already formed layer results in formation of a thin selective layer. Reaction time can also influence the thickness of the MPCM. The MPCM characteristics can be varied through selection of monomers, concentration of monomers in the aqueous and organic phases, types of additives and their compositions in solutions, organic solvent, and choice of substrate membrane.

The MPCM can be fabricated via crosslinking a polyamine reactive macrocycle monomer. The amine groups can be present in the ring of the reactive macrocycle. In one or more embodiments, the polyamine macrocycle is a trianglamine having the structure set forth in formula I:

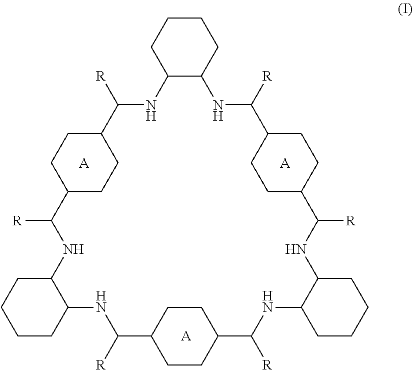

wherein:
each A is a macrocycle linker (i.e., derived from the aromatic dialdehyde) and can be independently a substituted or unsubstituted phenyl, a substituted or unsubstituted biphenyl, a substituted or unsubstituted triphenyl, a substituted or unsubstituted terphenyl, a substituted or unsubstituted diphenyl ether, a substituted or unsubstituted naphthalene, or a substituted or unsubstituted anthracene, and
each R is independently nothing, a hydroxyl, an alkyl, or an alkoxy, with the proviso that when R is nothing the carbon atom to which the R group would be attached is bonded to at least two hydrogens (e.g., forming —CH₂—).

In some embodiments, each A can be independently selected from a moiety of structural formulas IIA-D:

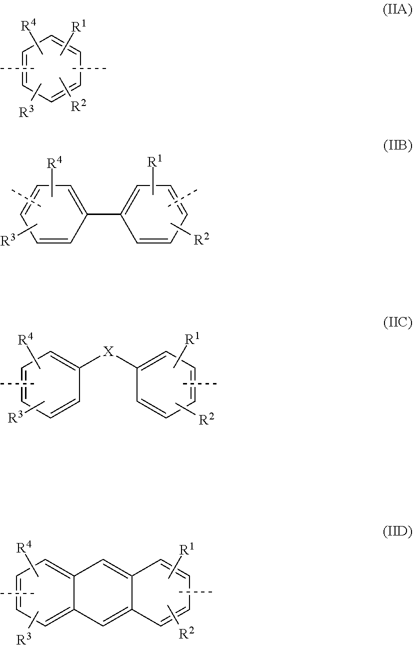

wherein [symbol] is a point of attachment; X is C, N, S, or O; and R¹, R², R³, and R⁴ are independently selected from a hydrogen, a halogen, a hydroxyl, a linear or branched alkyl, an alkoxy, an aryloxy, or an aralkoxy, as defined above.

In some embodiments, the trianglamine is a reaction product of a diaminocycloalkyl compound and an aromatic dialdehyde linker. The diaminocycloalkyl can be selected from diaminocyclohexanes and derivatives thereof, including substituted diaminocyclohexanes. Non-limiting examples of suitable diaminocyclohexanes include (+/−)-trans-diaminocyclohexane, cis-diaminocyclohexane, trans- and cis-diaminocyclohexane, (1S,2S)-(+)-diaminocyclohexane, (1R,2R)-(−)-diaminocyclohexane, and derivatives thereof which are capable of forming a trianglamine when reacted with an aromatic dialdehyde. The aromatic dialdehyde linker can be selected from aromatic dialdehydes and derivatives thereof, including substituted aromatic dialdehydes. Non-limiting examples of suitable aromatic dialdehydes include terephthalaldehyde, 2,6-naphthalenedialdehyde, 1,4-naphthalenedialdehyde, 2,7-naphthalenedialdehyde, 1,5-naphthalenedialdehyde, 4,4′-diphenyldialdehyde 4,4′-triphenyldialdehyde, diphenyl ether-4,4′-dialdehyde, diphenoxyethane-4,4′-dialdehyde, diphenoxybutane-4,4′-dialdehyde, diphenylethane-4, 4′-dialdehyde, isophthalaldehyde, diphenyl ether-3,3′-dialdehyde, diphenoxyethane-3,3′-dialdehyde, diphenylethane-3,3′-dialdehyde, 1,6-naphthalenedialdehyde, anthracene-9,10, dialdehyde, etc., and sulfonated products thereof, fluoroterephthaldialdehyde, difluoroterephthaldialdehyde, bromoterephthaldialdehyde, methylterephthaldialdehyde, dimethylterephthaldialdehyde, ethyl terephthaldialdehyde, methoxyterephthaldialdehyde, ethoxyterephthaldialdehyde, and the like. In some embodiments, the trianglamine is a reaction product of terephthalaldehyde and 1, 2-diaminocyclohexane.

As mentioned above, a polyfunctional acyl halide monomer may react with a plurality of trianglamine monomers to form a polyamide film (i.e., resulting from an amide reaction between the acyl halide monomers and trianglamine). Suitable polyfunctional acyl halide compounds include aromatic polyfunctional acyl halides and alicyclic polyfunctional acyl halides. Examples of suitable polyfunctional acyl halide compounds include, without limitation, trimesic acid chloride, terephthalic acid chloride, isophthalic acid chloride, biphenyl dicarboxylic acid chloride, and naphthalene dicarboxylic acid dichloride. Non-limiting examples of alicyclic polyfunctional acyl halide compounds include cyclopropane tricarboxylic acid chloride, cyclobutane tetracarboxylic acid chloride, cyclopentane tricarboxylic acid chloride, cyclopentane tetracarboxylic acid chloride, cyclohexane tricarboxylic acid chloride, tetrahydrofuran tetracarboxylic acid chloride, cyclopentane dicarboxylic acid chloride, cyclobutane dicarboxylic acid chloride, cyclohexane dicarboxylic acid chloride, and tetrahydrofuran dicarboxylic acid chloride. In one embodiment, the polyfunctional acyl halide compound is terephthaloyl chloride (TPC).

In one embodiment of the present disclosure, the MPCM is fabricated by crosslinking a trianglamine monomer formed by reacting terephthalaldehyde and 1, 2-diaminocyclohexane, with a terephthaloyl chloride crosslinker.

The six reactive amino groups per trianglamine molecules can lead to the formation of a high cross-linking density. The percentage of reacted secondary amine groups (e.g., —NH—) in the MPCM, as determined using X-ray photoelectron spectroscopy (XPS), may be at least about 20%, or at least any one of, equal to any one of, or between any two of 0.15%, 0.16%, 0.17%, 20%, 30%, 32%, 33%, 34%, 40%, 49%, 50%, 51%, 60%, 65%, 66%, 67%, 68% 69%, 70%, 71%, 72%, 73%, 74%, 75%, 76%, 77%, 78%, 79% 80%, 81%, 82%, 83%, 84%, 85%, 86%, 87%, 88%, 89%, 90%, 95%, and 100% or less. The degree of crosslinking of trianglamine in the MPCM, as determined from the percentage of reacted amine groups, may be such that each of at least a portion of trianglamine units are bonded to at least two other trianglamines, including 2, 3, 4, 5, or 6 other trianglamine units. A high cross-linking density confers excellent performance for molecular separation in an organic solvent medium.

The trianglamine content of the MPCM may be at least about 20%, or at least any one of, equal to any one of, or between any two of 20%, 30%, 40%, 50%, 60%, 65%, 66%, 67%, 68% 69%, 70%, 71%, 72%, 73%, 74%, 75%, 76%, 77%, 78%, 79% 80%, 81%, 82%, 83%, 84%, 85%, 86%, 87%, 88%, 89%, 90%, 95%, and 100% or less by weight, based on the total weight of the membrane (e.g., the combined weight of the trianglamine and polyfunctional acyl halide compound on a dry basis).

The MPCM thickness may be at least about 2 nm, such as a value greater than 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25 nm, or greater.

The surface of the MPCM can be characterized by its roughness (e.g., by root-mean-square roughness). The root-mean-square roughness for the membranes may be no greater than about 10 nm, such as less than 10, 9, 8, 7, 6, 5, 4, 3, 2, 1, or 0.1 nm. A root-mean-square roughness below 1 nm, indicates the highly smooth and flat morphologies of the films, which can be confirmed by SEM, for example.

The pore size and pore size distribution of the MPCM will be tunable. For example, the length of the macrocycle linker (i.e., A in Formula I above) can be expanded, keeping analogous chemistry, or the effective channel can be constricted with the addition of side groups. In some cases, the pore size is at least about 0.5 Å, such as sizes greater than 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0 Å or greater.

The MPCM may be characterized by its wettability. For example, a trianglamine cross-linked layer can a high proportion of nonpolar groups, i.e., cyclohexyl, coming from the trianglamine moiety which will give rise to water contact angles greater than 90°. Hydrophobic MPCM show good compatibility for apolar solvents like hexane. In some embodiments, the water contact angle of the membrane surface is at least 75°, at greater than 75°, greater than 85°, greater than 90°, or greater than 95°. In some cases, the water contact angle is within a range of 750 and 115°.

The MPCM exhibit high stability in a wide array of organic solvents and chemical species, even at high concentrations (e.g., high concentrations of dye molecules). This stability, and optionally a high permeance, may be observed in polar solvents, apolar solvents, or combinations or mixtures of solvents including at least one polar solvent and at least one apolar solvent. Examples of organic solvents in which the membranes disclosed herein exhibit high stability, and optionally high permeance, include one or more of the following: water, methanol, ethanol, isopropanol, acetone, acetonitrile, chloroform, toluene, hexane, dimethylformamide (DMF), dimethyl sulfoxide (DMSO), tetrahydrofuran (THF), n-methyl 2-pyrrolidone (NMP). In some embodiments, the membranes exhibit high stability in the presence of one or more of the following organic solvents: aromatic hydrocarbons, aliphatic hydrocarbons, ketones, glycols, chlorinated solvents, esters, ethers, amines, nitriles, aldehydes, phenols, amides, carboxylic acids, alcohols, furans, lactones, dipolar aprotic solvents, toluene, xylene, benzene, styrene, anisole, chlorobenzene, dichlorobenzene, chloroform, dichloromethane, dichloroethane, methyl acetate, ethyl acetate, isopropyl acetate, butyl acetate, methyl ether ketone (MEK), methyl iso butyl ketone (MIBK), acetone, ethylene glycols, ethanol, methanol, isopropanol, propanol, butanol, hexane, heptane, cyclohexane, dimethoxyethane, methyl tert butyl ether (MTBE), diethyl ether, adiponitrile, N,N-dimethylformamide, dimethylsulfoxide, N,N-dimethylacetamide, dioxane, nitromethane, nitrobenzene, pyridine, carbon disulfide, tetrahydrofuran, methyl-tetrahydrofuran, N-methyl pyrrolidone, N-ethyl pyrrolidone, acetonitrile, and mixtures or blends thereof.

The MPCM of the present disclosure herein may have one or more of the following characteristics: possessing properties conferred by interfacial polymerization (e.g. thicknesses<20 nm, tunable pore size and pore interconnectivity); being defect-free, optionally with at least one of a continuous, smooth, and flat surface, and optionally without one or more of pinholes and cracks; amorphous structure (e.g., the polymeric network lacks crystallinity or order as determined by wide-angle X-ray diffraction (XRD); a high degree of crosslinking (e.g., hyper-crosslinked); possessing charge selectivity and optionally a strict size selectivity and/or chiral selectivity; nano-isoporosity, which is optionally interconnected; a high content of trianglamine; a high stability in organic solvents; exceptional permeance for apolar and/or polar solvents; high permeance; hydrophobicity, hydrophilic, or a combination thereof (e.g., possessing a Janus property).

The MPCM may be a supported membrane, such as thin film composite (TFC) membrane. The thin film membranes comprises a selective layer of crosslinked macrocycles, such as crosslinked trianglamines. The selective layer can have nanoscale thickness (i.e., a nanofilm layer). The support can be a porous support. The support can be selected from polyacrylonitrile (PAN), polyvinylidene fluoride (PVDF), cellulose acetate, polyvinylpyrrolidone (PVP), polysulfone (PSF), polyethersulfone (PES), polyimide (PI), polyetherimide (PEI), polybenzoimidazole (PBI), polypropylene (PP), polyethylene (PE) or polytetrafluoroethylene (PTFE). Methods of forming porous polymeric supports for TFCs using this polymers are known in the art. The porous support has a pore size in a range of 1 to 1000 nm.

In some cases, the MPCM is fabricated as a freestanding film. The freestanding film can be deposited or transferred to a support, such as a ceramic support (e.g., silica, alumina, etc.) The freestanding film can have a nanoscale thickness (i.e., a MPCM nanofilm). The morphology of the freestanding film can be substantially flat (e.g., even and smooth (i.e., characterized by low roughness).

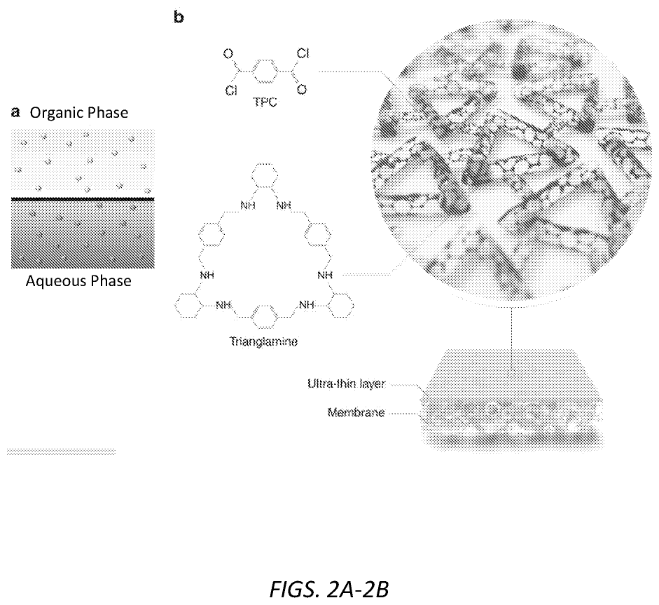

Methods of fabricating a MPCM membrane are also described. In a general method, a MPCM membrane can be fabricated by the interfacial polymerization of trianglamine solubilized in water, in contact with an organic phase, containing an acyl halide (e.g., acyl chloride). For example, interfacial polymerization of an aqueous trianglamine monomer formed by reacting terephthalaldehyde and 1, 2-diaminocyclohexane (i.e., the trianglamine shown in FIG. 2B), in contact with an organic phase containing terephthaloyl chloride. By employing easily customized molecular hosts, such as trianglamines, the selectivity of the MPCM can be tailored significantly “on-demand” without compromising the overall permeability of the system.

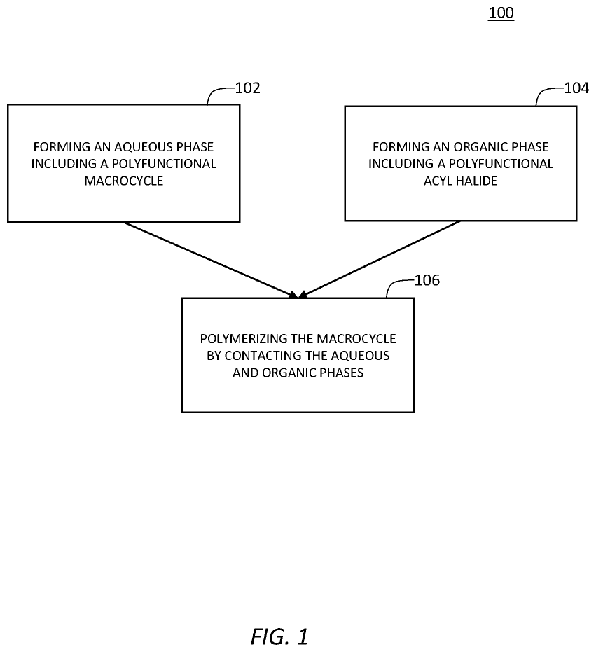

FIG. 1 describes an embodiment of the general method of making a MPCM of the present disclosure. As shown in FIG. 1, the method can include an aqueous phase forming step 102 by dispersing and optionally dissolving the reactive macrocycle in water; an organic phase forming step 104 by dissolving a polyfunctional acyl halide in an organic solvent; and a polymerization step 106, whereby the aqueous phase and the organic phase are contacted to form the MPCM.

Step 102 can further include sonicating the dispersion, or otherwise mixing, stirring, or agitating the dispersion, either mechanically or physically, with or without sonication. Dissolution of the trianglamine can be promoted by adjusting the pH. For example, a sufficient amount of an acid, such as 0.1M HCl, may be added to the dispersion to provide a pH of about 6.6. Solubilization can be demonstrated by a change in the turbidity of the aqueous phase, whereby the aqueous phase becomes increasingly transparent. The aqueous phase can then be clarified by filtration (e.g., using a syringe filter with 0.022 m pore size). The aqueous phase can be stored (e.g., refrigerated) and/or used directly in MPCM fabrication. In some cases, the aqueous phase is impregnated in a support (e.g., a TFC support such as ultrafiltration membranes (e.g., polyacrylonitrile (PAN) ultrafiltration membranes, polyimide ultrafiltration membranes, etc.). Prior to impregnation, the support can be fixed with PTFE frames. Impregnation includes contacting the support with the aqueous phase for at least 10 seconds (e.g., about 10 minutes), and then removing any excess (e.g., by decanting and/or blotting). Alternatively the aqueous phase can be added to a vessel comprising a support.

The concentration of trianglamine in the aqueous phase can be varied to tune the MPCM permeance. For example, the concentration of trianglamine can be at least about 0.01 wt % and up to 2 wt %, such as about 0.5 to 1.5 wt %, about 0.75 to about 1.25 wt %, or about 1.0 wt %, based on the total weight of the aqueous phase.

In step 104, the organic phase may be formed by adding the polyfunctional acyl halide compound to an organic solvent, optionally with at least one of sonicating, mixing, stirring, agitating, and the like. The organic phase includes a solvent which is immiscible with the aqueous phase and that dissolves or solubilizes the polyfunctional acyl halide compound, such as hexane, cyclohexane, heptane, octane, nonane, decane, undecane, dodecane, tridecane, tetradecane, heptadecane, hexadecane, cyclooctane, ethylcyclohexane, 1-octene, 1-decene, and the like, and combinations thereof. In some cases, the organic phase is TPC in hexane.

The concentration of polyfunctional acyl halide of the organic phase affects the MPCM performance. For example, as discussed below, a low concentration of TPC leads to high permeance but low rejection, possibly due to defects in the film. When the TPC concentration of the organic phase is 0.1% (w/v) the membrane performance remains practically stable, indicating that a defect-free film can be formed above this concentration.

In step 106, polymerization may proceed under ambient conditions (e.g., room temperature of about 25° C. and atmospheric pressure; and relative humidity ranging from 40% to 80%). The reaction time can be varied based on the desired MPCM thickness. Suitable reaction times include 5 seconds to 10 minutes. For example, a reaction time of 10 seconds can fabricate a film layer of about 3.5 nm in situ on a porous support, a 5 min reaction time or longer can fabricate a 10 nm polymerized film in situ on a porous support, a free standing film of about 17-20 nm can be fabricated at the interface between the aqueous and organic phases after about 10 min reaction time. At least one advantage of the present method 100 is that it does not require and thus may not involve a step in which a sacrificial layer is applied. Initiating polymerization on an impregnated (e.g., saturated) support can include immersing the support in the organic phase.

A free-standing MPCM can be deposited on a silica wafer or alumina support. In this case, the support can be provided in a reaction vessel (e.g., a petri dish). The aqueous phase can be added to the vessel, and then the organic phase can be added to the vessel. Following the desired reaction time, the solutions can be removed from the vessel using a syringe, pump, or other similar device, such that the resulting film is disposed on (i.e., lowered onto) the silica wafer or alumina support.

In some cases, method 100 further includes a washing step including washing the MPCM with a volume of organic solvent to remove unreacted monomers.

Various parameters of the reaction may be selected or modified to tailor various properties of a MPCM of the present disclosure. Examples of said parameters include, without limitation, reaction time, concentration of the reactive macrocycle monomer in the aqueous phase, the species of polyfunctional macrocycle, etc. For instance, MPCM thickness may be increased by increasing the reaction time of the interfacial polymerization, although infinite reaction times may not correspond to infinitely large membrane thicknesses, and thus there may be, in some instances, a threshold reaction time after which further increases in membrane thickness are no longer observed. MPCM permeance may decrease with increasing reaction time and/or increasing membrane thickness. MPCM permeance may increase by decreasing the monomer concentration in the aqueous phase during membrane preparation, in comparison to membranes prepared from aqueous phases with higher monomer concentrations.

MPCM selectivity (e.g., solute rejection) may be unaffected by reaction time and/or membrane thickness. While not wishing to be bound to a theory, it is believed that membrane selectivity may be attributed, at least in part, to the high reactivity of the reactive macrocycle monomer and sieving performance of the resulting polymeric film which effectively rejects certain molecules based on molecular weight and/or molecular diameter from passing therethrough. For example, a highly reactive macrocycle such as a trianglamine can generate a dense separating layer rapidly (e.g., in a 10 s reaction). Sieving performance can be attributed to the hyper-cross-linked network structure of the trianglamine and acyl chloride. The MPCM may exhibit charge selectivity based on the properties of the cavity. For example, the electron-rich cavity of a trianglamine monomer largely blocks/retains negatively charged molecules, while neutral molecules and/or positively charged molecules may pass through the MPCM. In some embodiments, neutral molecules may pass through the membrane, whereas negatively charged molecules may be retained or rejected, or positively charged molecules may pass through the membrane, whereas negatively charged may be retained or rejected. The MPCM may exhibit size selectivity in which molecules above a certain molecular weight and/or a certain diameter are rejected by the membrane. The MPCM may exhibit chirality selectivity. For example, the homochirality of trianglamine can provide a MPCM that selectively permeate levorotary molecules. Stated differently, the membranes may selectively reject dextrorotary molecules. While not wishing to be bound to a theory it is believed that the chirality selectivity may be derived from the asymmetric environment of trianglamine macrocycles for guest molecules through interactions such as hydrogen bonding, π-π stacking, and CH-π interactions.

The MPCM of the present disclosure can be part of a system for filtration, such as a microfiltration, ultrafiltration, nanofiltration (e.g., organic solvent nanofiltration), reverse osmosis, forward osmosis, membrane distillation, reverse electrodialysis, deionization, or pervaporation system. The system can include a membrane module including a feed side and a permeate side separated by a membrane. The feed side may include a feed inlet and a feed outlet. A feed stream including one or more solutes and one or more solvents (e.g., one or more of organic solvents and water) may enter the feed side through the feed inlet and may discharge as a retentate stream through the feed outlet. The permeate side may include a permeate inlet and a permeate outlet. A permeate stream including a permeate may discharge through the permeate outlet. The membrane may include any MPCM of the present disclosure.

In some embodiments, the feed stream includes one or more polar solvents, non-polar solvents, protic solvents, aprotic solvents, non-organic solvents, and organic solvents. In some embodiments, the feed stream includes at least one of the following: aromatic hydrocarbons, aliphatic hydrocarbons, ketones, glycols, chlorinated solvents, esters, ethers, amines, nitriles, aldehydes, phenols, amides, carboxylic acids, alcohols, furans, lactones, dipolar aprotic solvents, toluene, xylene, benzene, styrene, anisole, chlorobenzene, dichlorobenzene, chloroform, dichloromethane, dichloroethane, methyl acetate, ethyl acetate, isopropyl acetate, butyl acetate, methyl ether ketone (MEK), methyl iso butyl ketone (MIBK), acetone, ethylene glycols, ethanol, methanol, isopropanol, propanol, butanol, hexane, heptane, cyclohexane, dimethoxyethane, methyl tert butyl ether (MTBE), diethyl ether, adiponitrile, N,N-dimethylformamide, dimethylsulfoxide, N,N-dimethylacetamide, dioxane, nitromethane, nitrobenzene, pyridine, carbon disulfide, tetrahydrofuran, methyl-tetrahydrofuran, N-methyl pyrrolidone, N-ethyl pyrrolidone, acetonitrile.

In some embodiments, the system can be used by contacting a first side (e.g., a feed side) of a membrane with a feed stream including one or more solutes and one or more solvents, and collecting a permeate from a second side (e.g., a permeate side) of the membrane. The feed stream may include one or more solutes dissolved and/or solubilized in the one or more solvents. The one or more solvents may include one or more organic solvents or water. The system and method of filtration may include at least one of microfiltration, ultrafiltration, nanofiltration (e.g., organic solvent nanofiltration), reverse osmosis, forward osmosis, membrane distillation, reverse electrodialysis, deionization, pervaporation, and the like.

In some embodiments, the MPCM of the system is a thin film composite (TFC) membranes in which a porous support is coated with a selective layer formed by interfacial polymerization. The selective layer can be about 20 nm or less, or about 10 nm or less. The selective layer can be a continuous layer of a hyper-crosslinked film exhibiting stability in a wide range of organic solvents, including both polar and apolar solvents. The selective layer can have an intrinsic porosity with pore sizes suitable for nanofiltration, such as for example around 6 Å (e.g., about 6.3 Å). The selective layer can have exhibit chiral selectivity and/or size selectivity. The selective layer may provide specific size and/or and charge molecular recognition for selective guest molecules separation.

The system can be utilized for the separation and/or purification of pharmaceutical products by nanofiltration with size ranges (molecular weight) below about 1000 g/mol.

In some embodiments, the system membrane is a MPCM as prepared by interfacial polymerization. The MPCM may include trianglamine monomers that produce an ultra-thin film with micro-isoporosity featuring both high permeance and sharp selectivity. The high molecular weight and ionized structure of trianglamine monomers contribute to its slower diffusion into, and lower solubility in the organic solution, compared with the commonly used monomers such as m-phenylenediamine (MPD). Consequently, ultrathin selective layers (e.g., about 10 nm or less) may be formed with a high content of embedded trianglamine (e.g., about 62 wt. %) (FIGS. 2A-2B). Due to its intrinsic microporous structure, trianglamines may provide permanent channels for fast solvent permeance. Furthermore, because each trianglamine macrocycle has multiple reacting sites for cross-linking, a hyper-cross-linked MPCM may be obtained, promoting high stability in harsh organic solvent environments, which is ideal for organic solvent nanofiltration (OSN) applications. The MPCMs may demonstrate exceptional permeance for both polar and apolar solvents, outperforming most of the commercial state-of-the-art organic solvent nanofiltration (OSN) membranes in the market. Moreover, the membranes may be highly sensitive to the shape and charge of the permeating molecules and may be easily scalable for direct industrial production using current membrane production technologies.

A two-in-one strategy for the fabrication of hyper-cross-linked thin-film composite membranes featuring ultrathin film with interconnected microporosity is presented. The unique structures were achieved by the interfacial polymerization of the macrocycle trianglamine. The membranes show excellent performance for organic solvent nanofiltration, compared to most of the previously reported state-of-the-art polymer membranes, with high solvent permeance over a wide range of solvent polarity. Because of the multiple cross-linkable sites on the trianglamine structure, a hyper-cross-linked polymer network is obtained for the membrane, which strongly guarantees the enhanced stability in harsh organic solvent environments. Significantly, with the high density of trianglamine units in the membrane and the unique electrostatic property of the cavity, excellent shape, and charge selectivity are observed. Furthermore, as the library of macrocycle molecules is vast and continuously increasing, the tunability of related membranes is expected to further increase. This work will inspire further development of macrocycle-based polymeric membranes with ultrathin and microporous structure by rational design of the molecular building blocks for high performance and energy-efficient separations.

### EXAMPLES

### Membrane Characterization

Construction of MPCM: Trianglamine was selected as a monomer for membrane fabrication based on its size, functionality and synthesis (yield≥90%). A further important advantage is the possibility of easily tuning the pore size by expanding the length of the macrocycle linker, keeping analogous chemistry, or by constricting the effective channel with the addition of side groups. To conduct interfacial polymerization, trianglamine solubilized in water, was contacted with an organic phase, containing acyl chloride. An ultrathin MPCM was obtained. The six reactive amino groups per trianglamine molecules led to the formation of a high cross-linking density with demonstrated excellent performance as membrane for molecular separation in organic solvent medium.

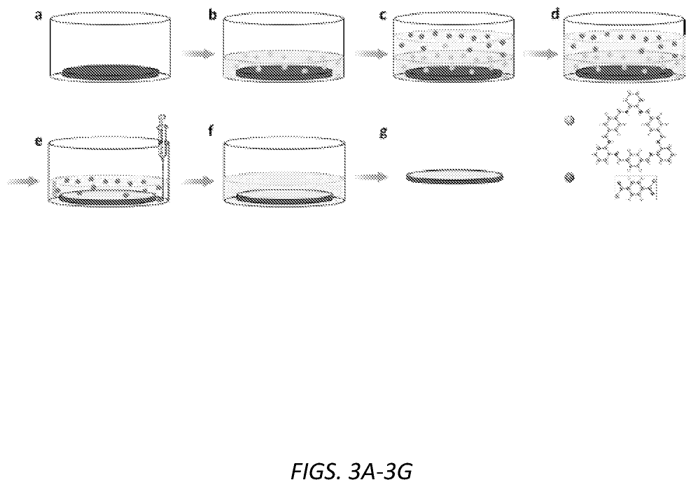

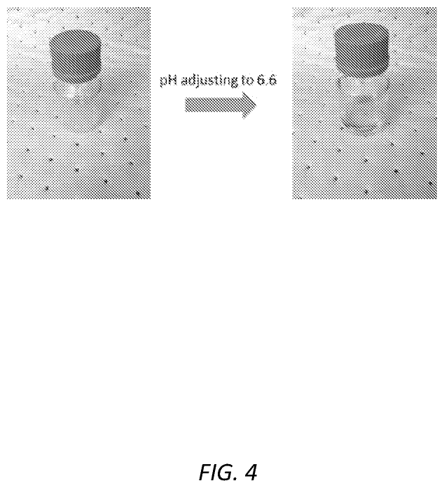

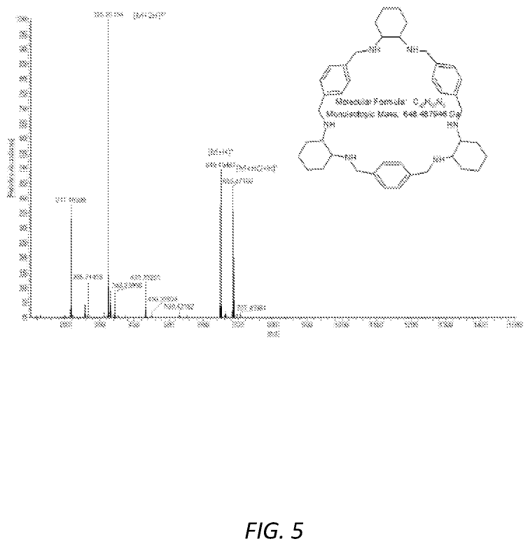

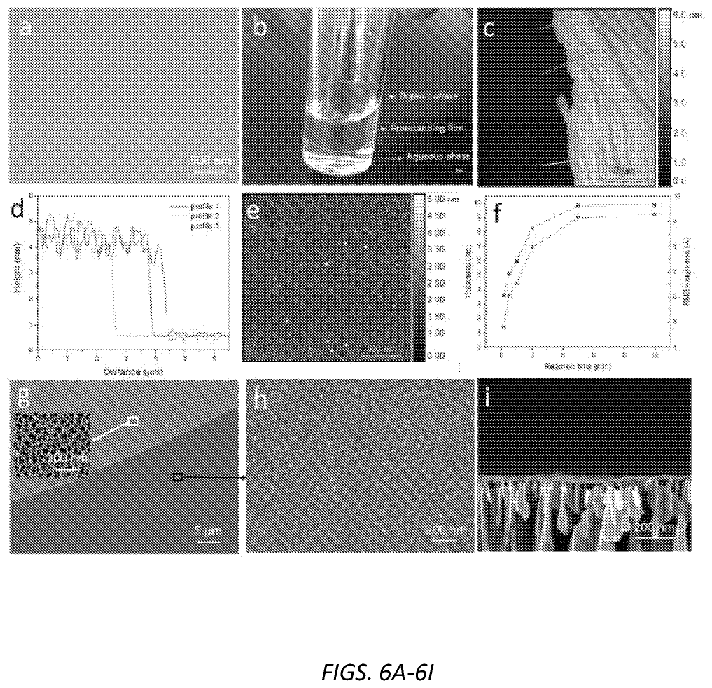

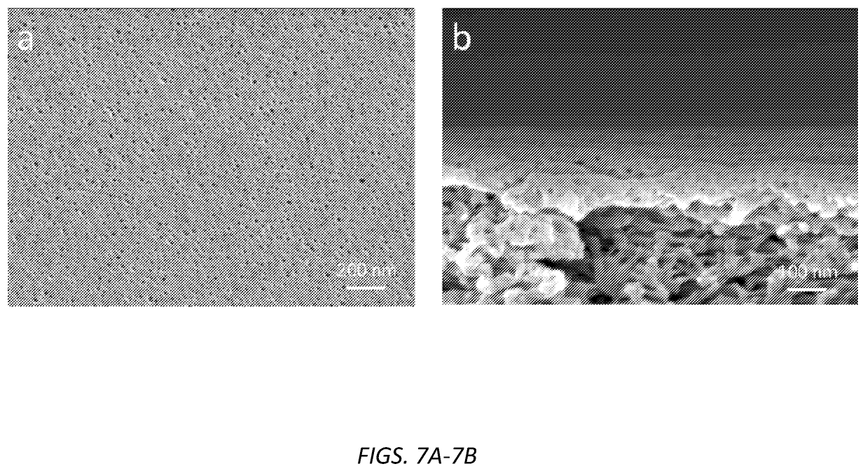

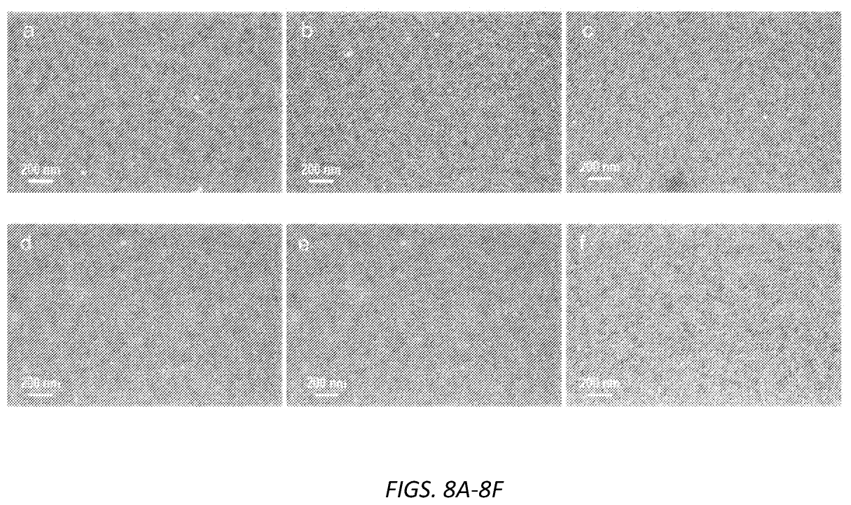

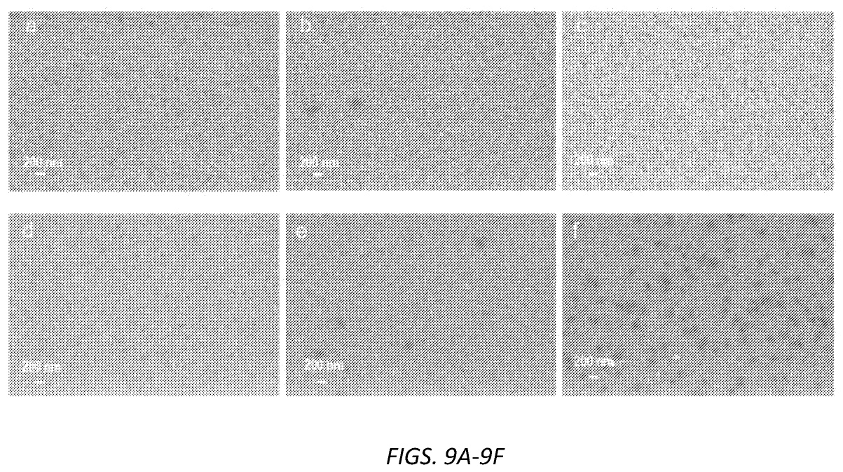

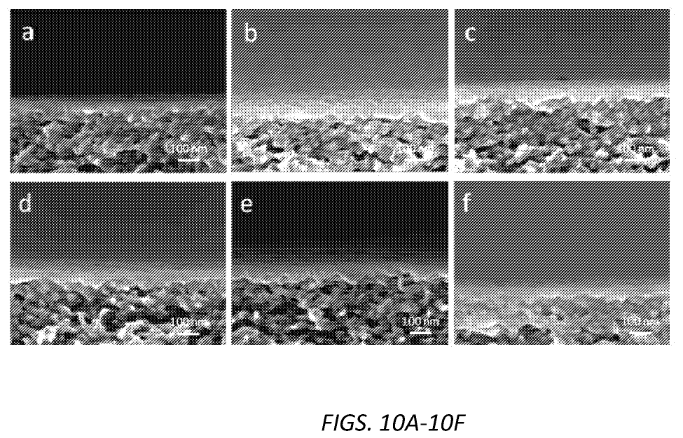

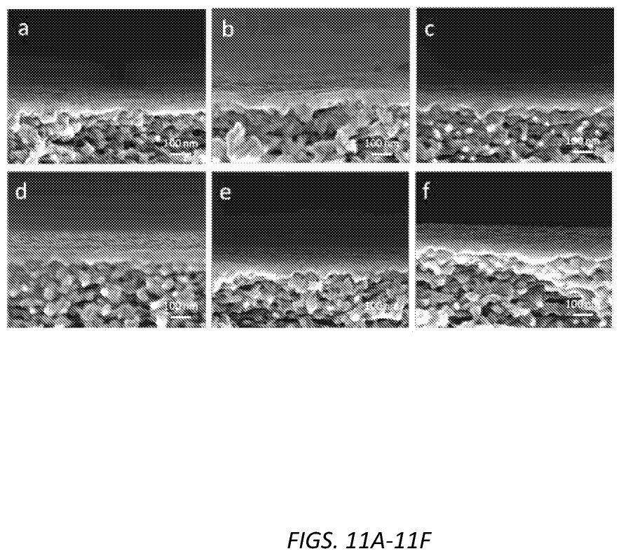

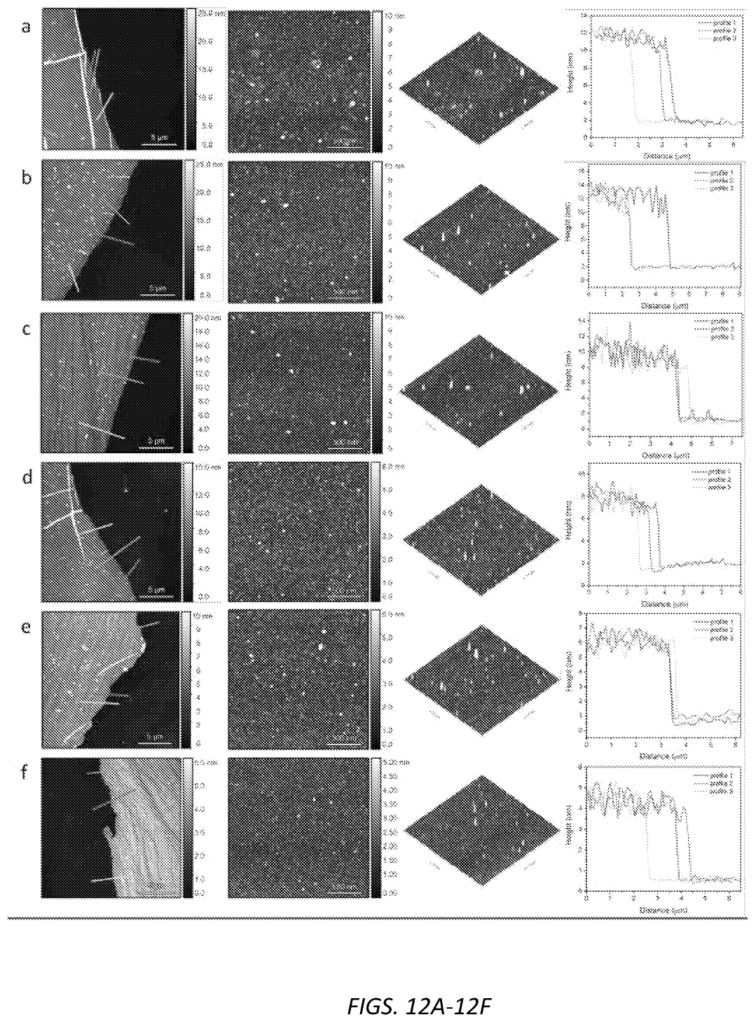

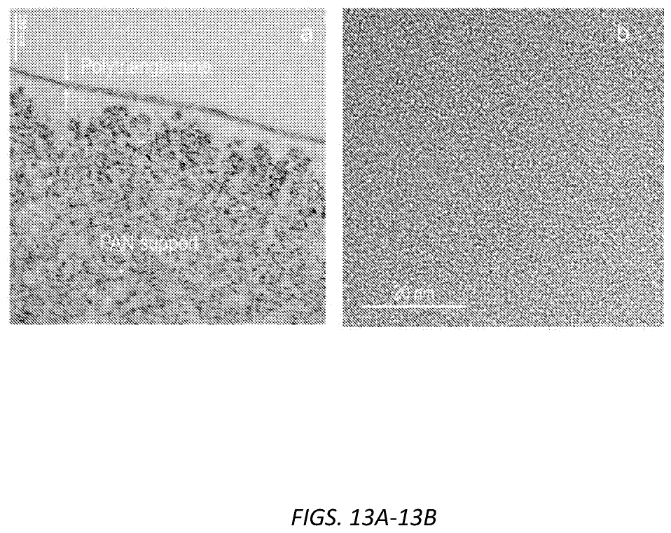

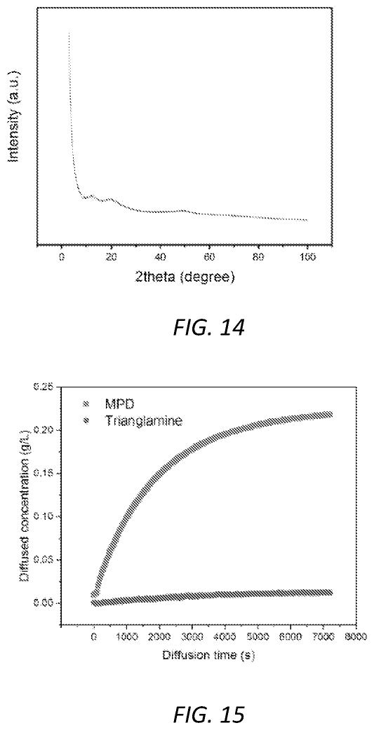

A certain amount of trianglamine (2 wt %) was dispersed in water, and the pH was adjusted by adding HCl until a transparent solution (FIGS. 4-5) was obtained. Terephthaloyl chloride (TPC) was added to the organic phase (FIGS. 2A-2B). The scanning electron microscopy (SEM) image of the interfacially polymerized layer on polyacrylonitrile (PAN) support showed a continuous and smooth surface without any identifiable pinholes or cracks (FIG. 6A and FIGS. 7-9). The thickness could not be precisely quantified in the cross-sectional SEM images since the boundary between the supports and the ultrathin nanofilms was hard to distinguish (FIGS. 10-11). Therefore, a free-standing cross-linked trianglamine nanofilm was prepared under analogous conditions, illustrated in FIG. 6B. The film was transferred onto another substrate, as described in FIGS. 3A-3G. FIGS. 6C-6E shows the atomic force microscopy (AFM) images of the film on a silicon wafer. The height profiles revealed that the thinnest film was around 3.5 nm (FIG. 6D). The thickness of the film was tunable depending on the conditions of synthesis (FIG. 6F, FIGS. 12A-12F). By increasing the reaction time from 10 s to 5 min, the thickness of the film increased from 3.5 to 10 nm. A further time increase did not lead to even thicker films. The same trend was observed for the film surface roughness. Nevertheless, all films had a root-mean-square roughness below 1 nm, indicating the highly smooth and flat morphologies of the films, which was in agreement with the SEM observations. The freestanding film with 10 min reaction time covering the alumina support is shown in FIGS. 6G-6I. The thickness of the film was measured from the cross-sectional image as being around 13 nm. Considering that the iridium coating for the SEM sample preparation was 3 nm thick, the thickness of the polymerized layer measured by SEM was consistent with the AFM result (FIG. 12A). The MPCM nanofilm had an even and flat morphology. The porous alumina support under the film was visible, indicating that it was extremely thin (FIG. 6H). The high-resolution TEM (HR-TEM) images revealed that the film thickness was around 17 to 20 nm and without any particular order or crystallinity (FIGS. 13A-13B). The lack of crystallinity was confirmed by wide-angle X-ray diffraction (XRD) (FIG. 14).

The formation of defect-free hyper-cross-linked trianglamine layers thinner than 20 nm for OSN application using the reported strategy with no additional steps, like applying a sacrificial interlayer, is advantageous in terms of selectivity, permeance, and potential for scaling-up. The mechanism of the film formation between the aqueous and organic phase was investigated. Since the polymer film formation took place more in the organic side of the interface, it was speculated that a high solubility and diffusivity of the aqueous monomer into organic phase could expand the polymerization zone and consequently increase the film thickness, and vice versa. As shown in FIG. 15, the diffusivity of trianglamine into the organic phase was extremely slow. This was ascribed to the ionic feature of the trianglamine monomer in the aqueous phase and to its large size compared to classical amines, such as m-phenylene diamine (MPD), used for interfacial polymerization. As a comparison, MPD shows much higher solubility and faster diffusivity under the same conditions. The reaction interface with trianglamine was less susceptible to convection, explaining the smoothness of the final layer.

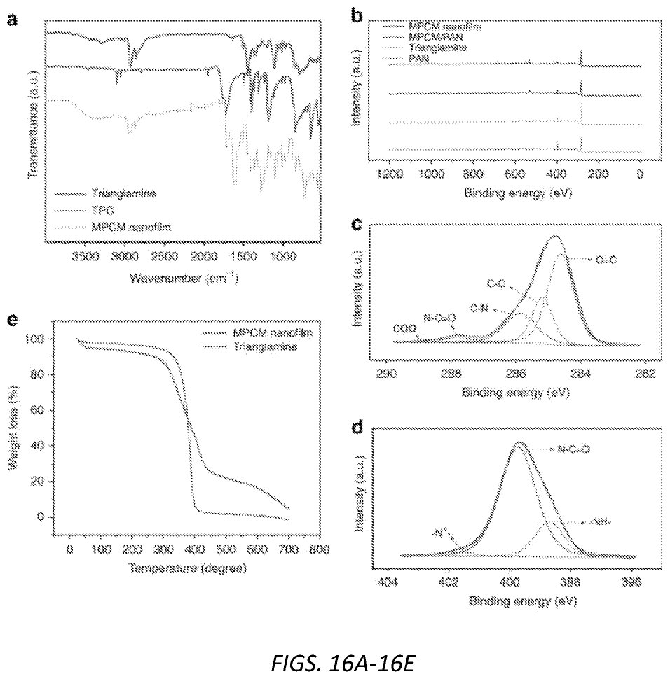

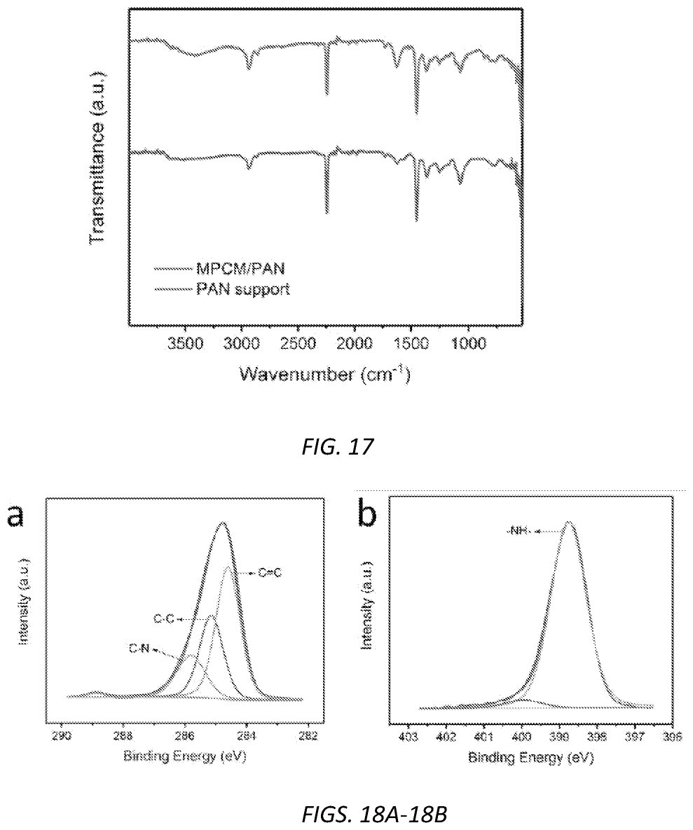

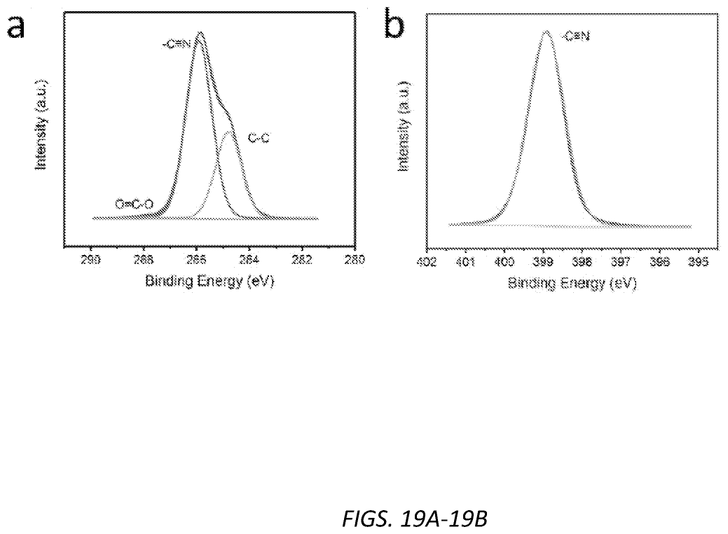

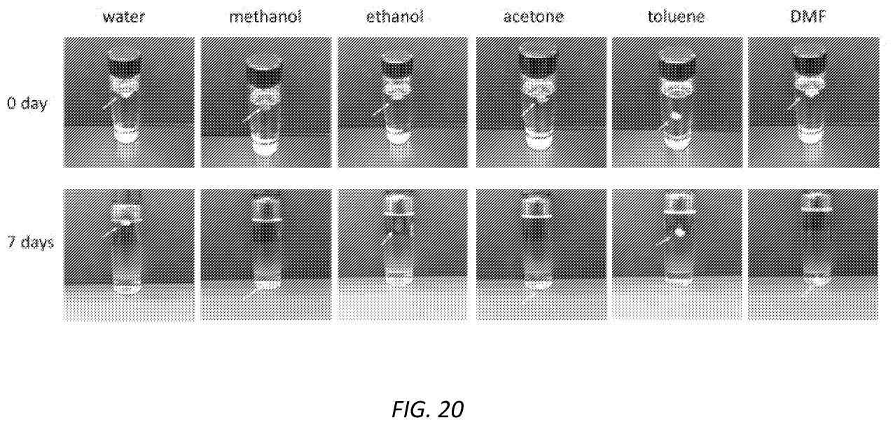

The chemical structure as polyamide of the MPCM was verified by ATR-FTIR spectra (FIG. 16A and FIG. 17). After polymerization, the stretching bands of O═C—Cl and —NH— groups, which appeared at 1760 cm⁻¹ and 3290 cm⁻¹ in the spectra of TPC and trianglamine, respectively, are greatly attenuated in the film. Simultaneously, a new strong stretching frequency band appeared at 1623 cm⁻¹, which was attributed to the —C═O bonds from secondary amide group. These results supported the formation of the polyamide film by amide reaction between TPC and trianglamine. Additional less pronounced changes in the spectrum after crosslinking appeared at 750, 1260 and 1400 cm, which were assigned to O═C—N bending in-plane, C—N stretching and a less specific absorption for polyamides, respectively. Besides these peaks, the overall similarity of the spectra of the network and the pristine trianglamine suggested that the macrocycle skeleton remained intact. To further quantify the cross-linking degree of the film, X-ray photoelectron spectroscopy (XPS) was carried out (FIGS. 16B-16D and FIGS. 18-19 and Table 1). Compared to the PAN support, the O/N ratio of the coated membrane increased from 0.04 to 0.7. The higher O/N ratio suggested that the top surface of the PAN support was covered by the MPCM nanofilm layer. However, due to the interference of the PAN support in the XPS spectrum of the selective layer, a precise XPS information of the pure MPCM on the PAN membrane could not be obtained. Therefore, a freestanding MPCM nanofilm was collected from the interface between the aqueous and organic phase to further clarify its chemical structure. As a comparison, the trianglamine monomer was also examined. As for the trianglamine, there was a main peak at 398.8 eV in the N1 s spectrum, corresponding to the —NH— (FIG. 18B). After polymerization, the main peak shifted to 399.7 eV (FIG. 16D), which was assigned to the N—C═O, and the original peak of —NH— largely decreased. The percentage of the reacted —NH— group per trianglamine molecule could be calculated based on the ratio between the peak of N—C═O (399.7 eV) and the whole signal, revealing that about 78% of the —NH— groups reacted with TPC. Because of the possible steric hindrance, not all —NH— groups were consumed in the reaction. The deconvolution of the C1 s narrow scan spectrum identified five component peaks: C═C (284.6 eV), C—C(285.1 eV), C—N(285.9 eV), N—C═O (287.8 eV) and COO (288.9 eV) 8,33 (FIG. 16C). Among them, the N—C═O and COO related only to the TPC segments. Two potential reasons were considered for these changes. During the polymerization reaction, either each TPC cross-linked two adjacent trianglamines, producing two N—C═O groups, or it just attached to one trianglamine without cross-linking, producing one N—C═O group and one COO. Based on the peak ratio of N—C═0 and COO, it was calculated that each trianglamine was covalently linked with 4 other trianglamines via TPC bridging, and the trianglamine content was estimated to be around 60 wt % in the membrane. Such hyper-cross-linking polymerization made the film dense and highly stable. As a result, the films had an excellent stability in a wide range of solvents (FIG. 20). The TGA measurement demonstrated their good thermal stability up to 300° C. (FIG. 16E). The sharp weight decrease ranging from 300° C. to 420° C. corresponds to the trianglamine moiety decomposition.

TABLE 1
Elements Compositions

| | C/% | O/% | N/% |
|---|---|---|---|
| PAN | 79.4 | 0.8 | 19.7 |
| MPCM/PAN thin-film composite membrane | 81.4 | 7.1 | 10.2 |
| Freestanding MPCM nanofilm | 83.4 | 9.3 | 7.3 |
| Trianglamine | 89.3 | 1.6 | 9.1 |

Based on the curve, it was estimated the trianglamine content in the film as being about 62 wt %, which was consistent with the result of the XPS evaluation.

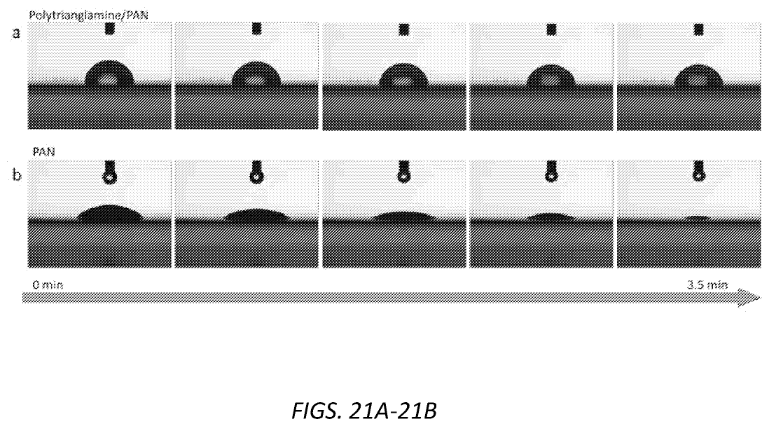

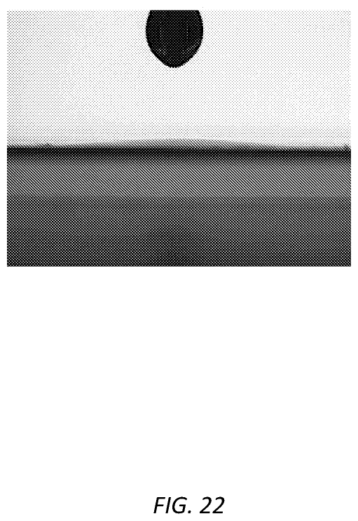

The hydrophobicity of MPCM was confirmed, as the contact angle was close to 90 degrees (FIGS. 21A-21B). The PAN support had a lower water contact angle. Furthermore, due to the porous structure, the water droplet gradually infiltrated the support. The trianglamine crosslinked layer had a high proportion of nonpolar groups, i.e., cyclohexyl, coming from the trianglamine moiety of top-layer and this was reflected in larger water contact angles. Consequently, the membranes showed good compatibility for apolar solvents like hexane (FIG. 22). Furthermore, due to the presence of the trianglamine layer, there was no detectable water penetration into the membrane, suggesting the formation of a continuous and dense film on the top of the PAN support.

XPS calculation. Because nitrogen element only comes from trianglamine, the percentage of reacted —NH₂ in trianglamine was calculated by following equation,

% of reacted —NH— group=S_{O═C—N}/S_{—NH—}+S_{—N—}+S_{O═C-N}

where S_{O═C-N}, S_{—NH—}, and S_{—N+—}were the peak area of O═C—N, —NH—, and —N+- components in N1 s narrow scan, respectively. The percentage of the reacted —NH₂ was calculated to be 78%.

Based on the results above, the crosslinking degree of the trianglamine in the film can be further calculated by following equations:

$$X + Y = 6 \times 0.78 \\ \frac{Y}{X + Y} = \frac{{S}_{COO}}{{S}_{N - C = O}}$$

where X represent the normalized number of crosslinked TPC in the film, Y the uncrosslinked TPC. X was calculated to be 4.1, and Y was calculated to be 0.6, which means that each trianglamine crosslinked with about 4 others to form the hyper-cross-linked membrane.

Trianglamine content in the film was calculated as follows:

$${w}_{trianglamine} = {W}_{trianglamine} / {W}_{trianglamine} + {W}_{TPC} = {M}_{trianglamine} / {M}_{trianglamine} + \frac{X}{2} \times {M}_{TPC} + Y \times {M}_{TPC}$$

where w_{trianglamine} was the weight percentage of trianglamine in the film, W_{trianglamine} and W_{TPC} were the weight of trianglamine and TPC, respectively, in the film, M_{trianglamine} and M_{TPC} were the molecular weight of trianglamine and TPC, respectively. The weight percentage of trianglamine in the film was calculated to be about 60%.

### Nanofiltration Performance of Membrane

To evaluate nanofiltration performance of the membrane, a dead-end apparatus (Sterlitech stainless steel cells, HP4750) was used to carry out the nanofiltration experiments with the feed volume of 200 mL. The effective separation area was 13.8 cm². Prior to the test, the membrane was placed in the cell and compacted with both pure water and methanol for 1 h, respectively, to wash away any possible unreacted monomers and make the membrane stabilized. For pure solvents filtration, the operating transmembrane pressure was applied at 0.5-4 bar, based on the permeance of each solvent. Pure organic solvent permeance was measured by weighing the permeated solvent every 10 min under a steady state. The membrane selectivity was tested in solute-separation experiments using a series of dye methanol solutions with concentration of 10-20 ppm at transmembrane pressure of 1 bar, unless otherwise stated. In order to exclude the effect of solute adsorption, both permeance and rejection were collected when a steady permeate was achieved. To investigate the influence of the transmembrane pressure on the permeate flux, experiments were performed under different pressures varying from 1 to 10 bar. The flux was measured by weighing the permeate every 10 min under a steady state. All nanofiltration experiments were performed at room temperature and repeated three times in parallel.

The solvent flux (J) is determined by equation 1, where Δw is the weight of permeate collected during filtration time Δt, A is the effective membrane area of the cell, ρ is the density of permeate, respectively.

J=Δw+ρAΔt (1)

Permeance is determined by equation 2, where ΔP is the applied transmembrane pressure for filtration experiment.

P=J+ΔP (2)

Rejection was calculated from the concentration of feed and permeate solution using the equation 3, where C_{f} and Cₚ represent concentration of feed solution and permeate, respectively.

$$R = ( 1 - \frac{{C}_{p}}{{C}_{f}} ) \times 100 \% \qquad ( 3 )$$

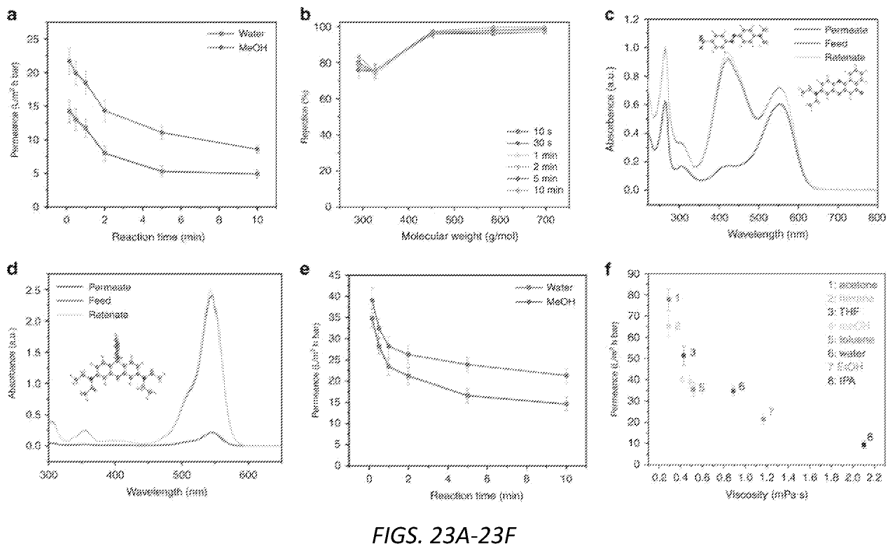

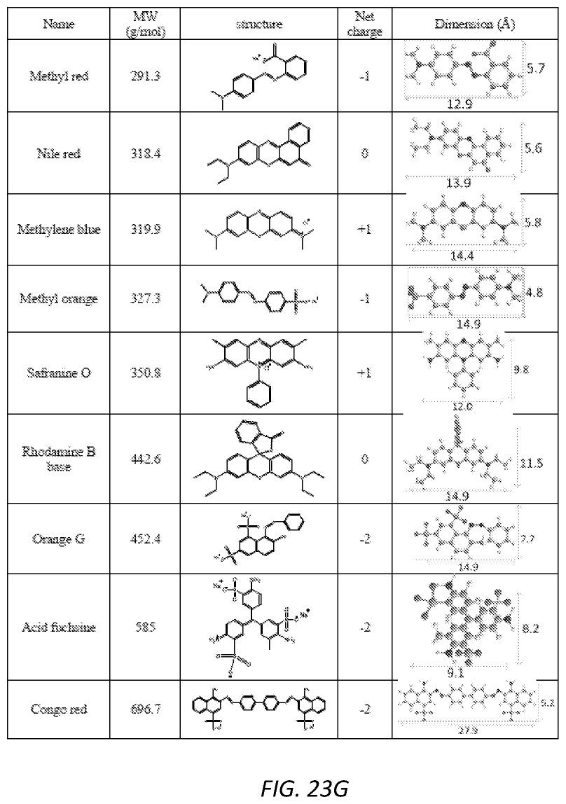

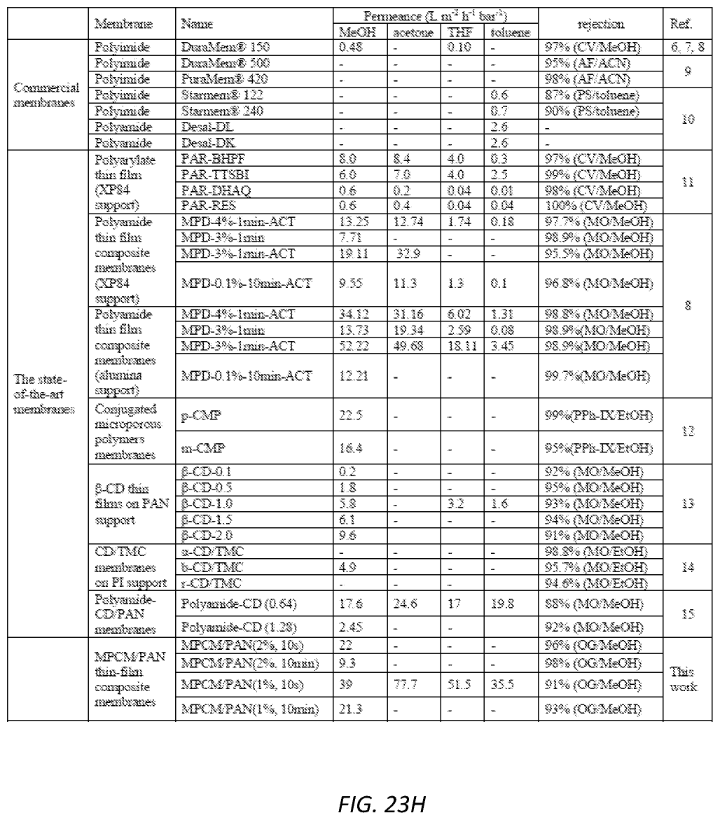

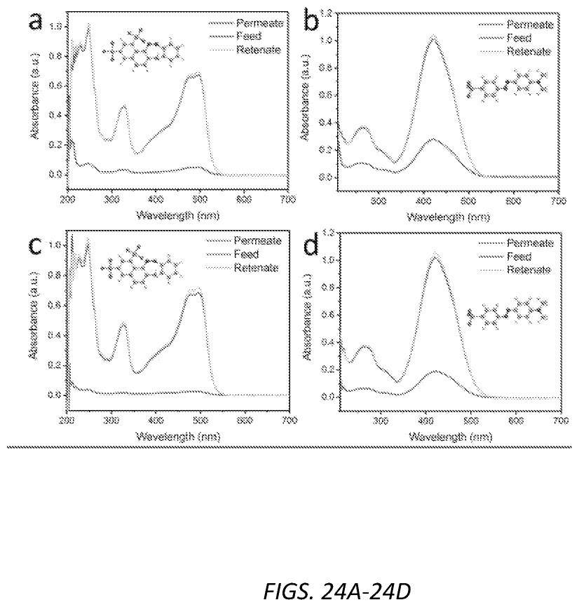

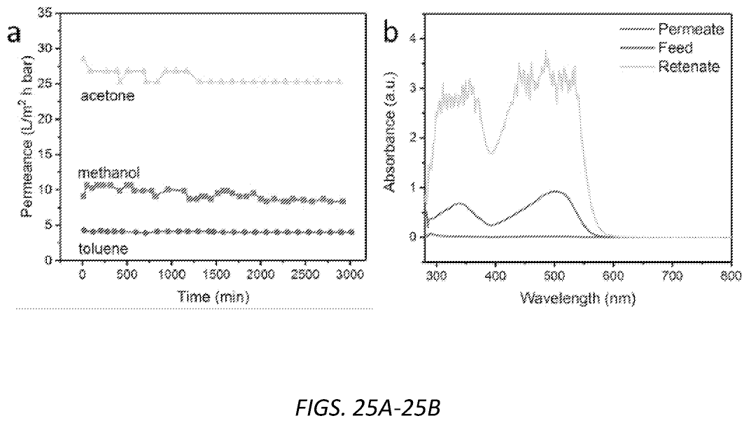

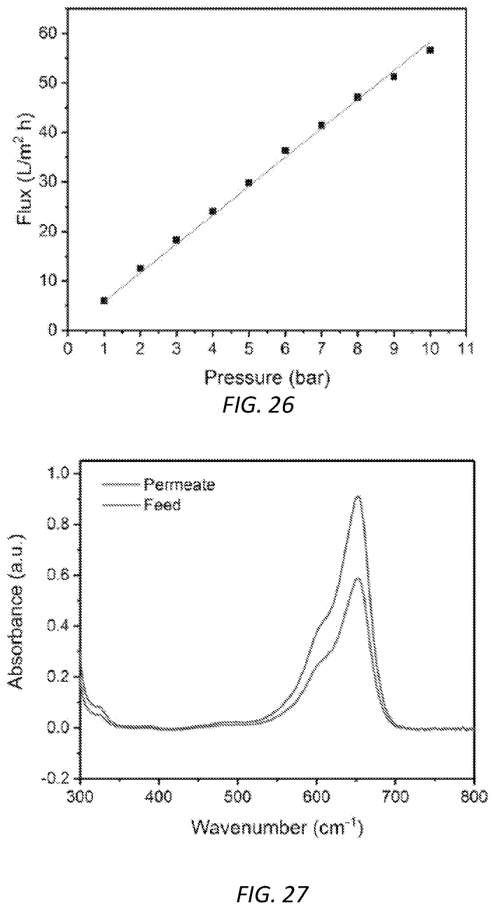

The OSN performances of the membranes was tested under certain pressure at 25° C. Ultrahigh liquid permeance may be achieved in ultrathin membranes because of the short transport path. To verify this further, the membrane permeance with different interfacial polymerization time was tested. As shown in FIG. 23A, the methanol permeance decreased from 22 L m⁻² h⁻¹ bar⁻¹ to 8.6 L m⁻² h⁻¹ bar⁻¹ and water permeance decreased from 14 L m⁻² h⁻¹ bar⁻¹ to 5 L m⁻² h⁻¹ bar⁻¹ with the reaction time increasing from 10 s to 10 min. More specifically, the permeance sharply decreased from 10 s to 5 min. This follows the trend of the trianglamine-polyamide film thickness, as demonstrated by AFM. FIG. 23B shows the membrane selectivity for a range of dye molecules (listed in FIG. 23G). Interestingly, the rejection of the membranes was not largely affected by the reaction time, implying that the dense separating layer can be generated even in 10 s reaction. This was attributed to the high reactivity of the trianglamine monomer and the effective sieving by the formed hyper-cross-linked network structure, greatly retaining the molecules going through. As a result, all membranes manifested a high rejection (>95%) for dyes with molecular weight larger than 450 g mol⁻¹. For the lower molecular weight dyes, such as methyl orange, the rejection was around 80%. In addition to the high permeance and rejection, the membranes also showed superior chemical stability. After filtration with various organic solvent, the membrane maintained its performance by demonstrating 96% and 83% rejection for orange G (OG) and methyl orange (MO), respectively (FIGS. 24A-24D), demonstrating its outstanding organic solvents resistance. The long-term stability of the membrane was confirmed by testing methanol, acetone, toluene, as well as dye solution of high concentration for more than 48 hours. No significant decrease of permeance and rejection was observed (FIGS. 25A-25B). The flux of the membrane was found to be linearly proportional to the applied pressure gradient (ΔP), reflecting that the microporosity within the separating layers remained unchanged with increasing compression (FIG. 26).

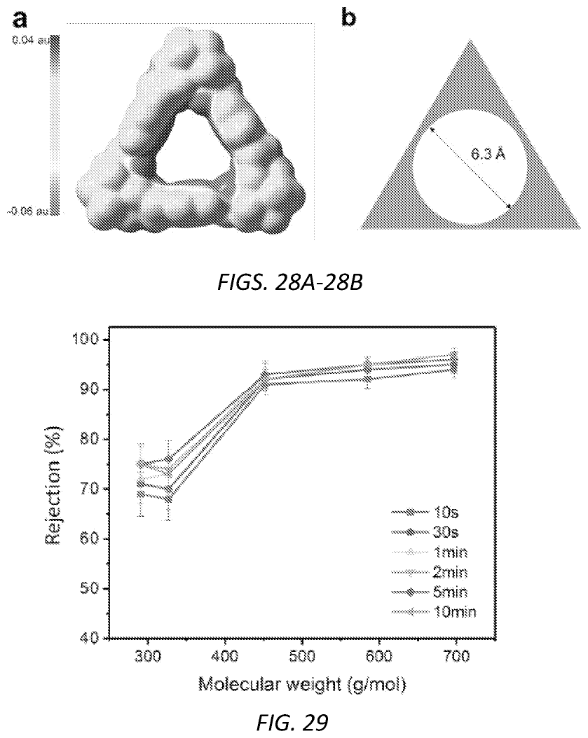

Significantly, the membrane was charge-selective for molecules with similar size. To illustrate it, the separation of neutral and anionic molecules with similar molecular weight was conducted. FIG. 23C shows the separation results performed with mixed solutions of MO (negative, 327 g mol⁻¹) and Nile Red (NR) (neutral, 318 g mol⁻¹). The neutral NR can freely pass through the membrane whereas the negatively charged MO was largely retained. The separation of cationic molecules, such as methylene blue (320 g mol⁻¹) has also been tested, and low rejection was observed (FIG. 27). These results can be attributed to the unique electrostatic property of the cavity of trianglamine and the overall negative charge of the membrane surface. As simulated in FIGS. 28A-28B, the cavity of trianglamine is electron-rich, which could prevent negatively charged molecules from going through it. Considering the high content of trianglamine in the film, the pathway for negatively charged molecules is limited, consequently resulting in high rejection. The membranes possess not only a charge selectivity but also a strict size selectivity, because of the rigid macrocycle structure, densely integrated in the selective layer. Neutral molecules, such as rhodamine B base and NR, are clearly rejected by size. Rhodamine is a bulkier molecule (442 g mol⁻¹) than NR (318 g mol⁻¹), and has a much higher rejection (91%) (FIG. 23D).

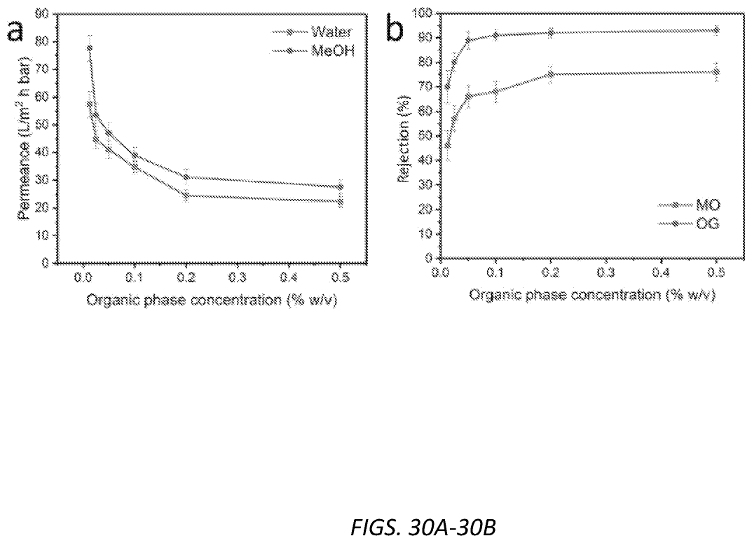

Higher permeance can be obtained by decreasing the trianglamine concentration in the aqueous phase during the membrane preparation. When 1% trianglamine was adopted as concentration in the aqueous phase, while keeping other membrane fabrication parameters the same, the permeance of membranes was doubled, without deterioration of the membrane selectivity (FIG. 23E). For example, with 10 s of reaction time, the methanol permeance reaches 39 L m⁻² h⁻¹ bar⁻¹ and the water permeance 35 L m⁻² h⁻¹ bar⁻¹. All membranes rejected more than 90% of dyes with molecular weight 450 g mol⁻¹ or larger (FIG. 29). This is an evidence that they out-perform the majority of the state-of-the-art membranes, including the commercial ones (FIG. 23H). Unlike the reaction time, the monomer concentration heavily affects the membrane performance. A low concentration of TPC leads to high permeance but low rejection, possibly due to defects in the film. For example, at a TPC concentration of 0.0125%, permeances of 77.6 L m⁻² h⁻¹ bar⁻¹ and 57.4 L m⁻² h⁻¹ bar⁻¹ were achieved for methanol and water, respectively, along with a low dye rejection (FIGS. 30A-30B). Once the TPC concentration increases to 0.1%, the membrane performance remains practically stable, indicating that a defect-free film can be formed above this concentration.

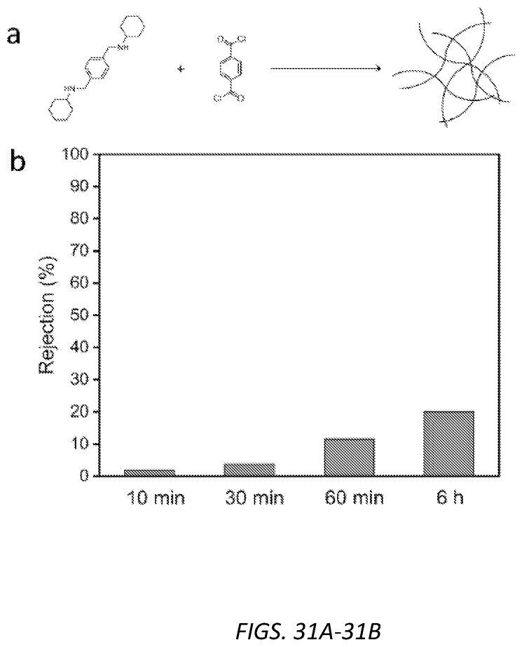

To investigate how important the membrane architecture is, a monomer analogous to trianglamine but without the macrocycle structure was used for the membrane preparation via the same procedure. This monomer is a linear fragment of trianglamine with two secondary amino groups, which can lead to practically the same chemistry as the MPCM, but without the intrinsic porosity provided by the macrocycles. Membranes prepared with this fragment instead of trianglamine had a congo red rejection lower than 20%, even when a prolonged reaction time up to 6 h was applied (FIGS. 31A-31B). This can be attributed to the fact that the permeation paths in this case are relatively dynamic and sensitive to the relaxation of chains during operation in organic solvents.

Since there are only two amino functional groups per fragment to react with two available acyl chloride groups per TPC molecule, linear chains are formed during the interfacial polymerization, instead of a rigid crosslinked network of trianglamines. The membrane selective layer is therefore constituted by physically entangled polymer chains, and the permeation paths are provided by the polymer interchain distances. Compared to the polymerized trianglamine, the lack of chemical crosslinking of these linear chains could be responsible for a lower membrane stability in long-term experiments.

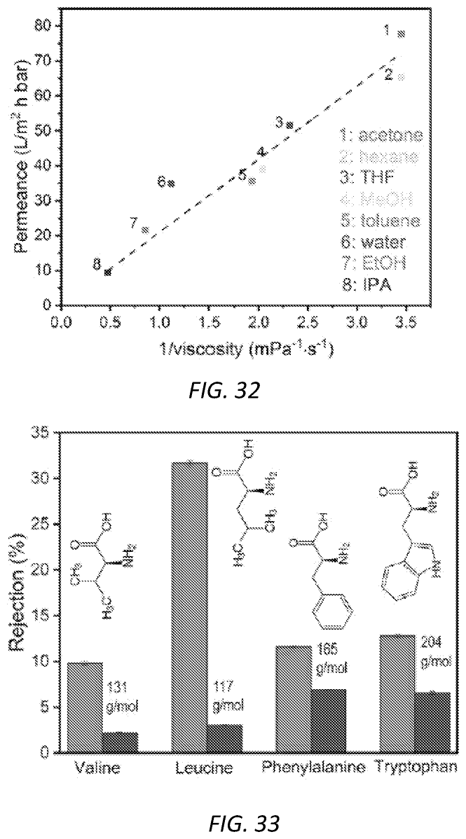

To further evaluate the potential of MPCM for OSN applications, the permeation of membranes prepared with 1% trianglamine in the aqueous phase and reaction time 10 s was measured for various organic solvents (Table 2). For molecular-selective nanofiltration membranes, both the thermodynamic interaction with the permeant and its size can influence the transport. In contrast to that observed for traditional polyamide composite membranes, fabricated from TMC and MPD, which are only permeable to polar organic solvents, but not to apolar ones, all tested solvents had a fast transport through the trianglamine membranes (FIG. 23F). This could be attributed to the presence of both hydrophilic (amide and carboxyl) and hydrophobic (cyclohexyl) groups in the MPCM network structure. Besides that, the ultralow thickness and permanent interconnected nano-isoporosity contribute to the high permeance. Nevertheless, the solvent permeance linearly increases in the inverse proportion to the viscosity (FIG. 32). The solvent with the lowest viscosity has the highest permeance. For example, acetone, with viscosity of 0.29 mPa·s, had a permeance of ˜77.7 L m⁻² h⁻¹ bar⁻¹, whereas for water it was 35 L m⁻² h⁻¹ bar⁻¹, despite the kinetic diameter being almost two times smaller than that of acetone. Isopropanol, with viscosity of 2.1 mPa·s, had the lowest permeance (˜9.4 L m⁻² h⁻¹ bar¹). Though having a kinetic diameter similar to isopropanol, THF exhibited high permeance (51.5 L m⁻² h⁻¹ bar¹), because of its low viscosity. Importantly, this membrane also shows hexane and toluene permeances of 65.3 L m⁻² h⁻¹ bar⁻¹ and 35.5 L m⁻² h⁻¹ bar⁻¹, respectively, which is much higher than the conventional polyamide membranes. For most of the solvents, the product of permeance and viscosity is almost constant. Therefore, the solvent transport in MPCM membranes should predominantly follow the pore-flow model, as a result of the permanent interconnected nano-isoporosity presence. But the solvent size alone plays an important role in the permeation process. Water, with the smallest molecular size (0.38 nm), had higher permeance than toluene, though it has higher viscosity.

TABLE 2
Hansen Solubility Parameter (δ) and Property
of Solvent Used for Nanofiltration Experiments

| | Molar volume | | | Hansen solubility parameter (δ) | | | |
|---|---|---|---|---|---|---|---|
| | (Vₘ)(cm³ | dₘ | Viscosity** | (MPa^{1/2})*** | | | |
| Solvents | mol⁻¹) | (nm)* | (10⁻³ Pas) | δ_{d} | δₚ | δₕ | δ |
| Water | 18.0 | 0.38 | 0.89 | 15.6 | 16 | 42.3 | 47.8 |
| Methanol | 40.7 | 0.51 | 0.49 | 15.1 | 12.3 | 22.3 | 29.7 |
| Ethanol | 58.5 | 0.57 | 1.17 | 15.8 | 8.8 | 19.4 | 26.6 |
| Isopropanol | 76.8 | 0.62 | 2.1 | 15.8 | 6.1 | 16.4 | 23.5 |
| Acetone | 73.9 | 0.62 | 0.29 | 15.5 | 10.4 | 7.0 | 21.0 |
| Hexane | 131.6 | 0.75 | 0.29 | 14.9 | 0 | 0 | 14.9 |
| Tetra- | 81.7 | 0.62 | 0.43 | 16.8 | 5.7 | 8.0 | 19.4 |
| hydrofuran | | | | | | | |
| Toluene | 106.8 | 0.7 | 0.52 | 18.0 | 1.4 | 2.0 | 18.2 |

*The molar diameter (dₘ) was calculated from prior reports using molar volume (Vₘ) of the solvent molecule from: m = 2 × (3Vₘ/4π N_{A} )1/3; where N_{A} is the Avogardo's number.
**Viscosity taken from prior reports.
***δ_{d} = solubility parameter due to dispersion forces, δₚ = solubility parameter due to dipoleforces, and δₕ = solubility parameter due to hydrogen bonding (or in general due to donor-acceptor interactions). See (Hansen Solubility Parameter Handbook).

Chiral separation: The chiral selectivity was tested for different kinds of amino acid. The filtration of optically pure amino acid enantiomers solution (L-Valine (50 mg/ml), D-Valine (50 mg/ml), D-Leucine (10 mg/ml), L-Leucine (10 mg/ml), D-Phenylalanine (20 mg/ml), L-Phenylalanine (20 mg/ml), D-Tryptophan (10 m/ml), L-Tryptophan (10 mg/ml)) was conducted using a hand extruder Genizer (effective membrane area of 1.13 cm²). The concentration of permeate was analyzed on Rudolph polarimeter Autopol V for two seconds and repeated five times, with laser wavelength of 365 nm. For racemic separation experiment, the feed solution contained equal concentration of L- and D-amino acid (50% L-amino acid: 50% D-amino acid): DL-Valine (25 mg/ml), DL-Leucine (5 mg/ml), DL-Phenylalanine (10 mg/ml) and DL-Tryptophan (2 mg/ml). The concentration of the permeate was analyzed using a Rudolph polarimeter Autopol V and UV-Vis absorbance equipment. All experiments were performed at room temperature and repeated three times in parallel.

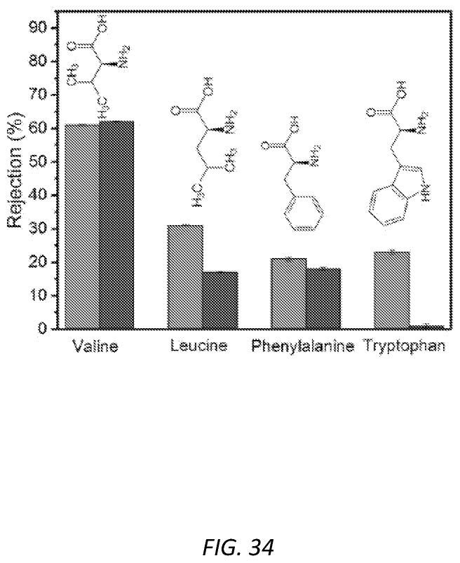

An important advantage of the membrane is that the homochirality of the trianglamine structure favors chiral selectivity. As shown in FIG. 33 and FIG. 34, several amino acids have been tested for chiral separation. Their sizes are all below the membrane cut-off and a high rejection was not expected, but rather a distinction between levorotary and dextrorotary molecules. Separation experiments were conducted on both scenarios: feed solutions containing a single enantiomer with either L- or D-amino acid and racemic solutions with equal concentrations of both L- and D-enantiomers of amino acids: Valine, Leucine, Phenylalanine and Tryptophan. Compared to the levorotary analogs, the membranes clearly rejected more the dextrorotary molecules, both in experiments with separated enantiomers and with racemic mixtures. The only exception was in the racemic of Valine, for which practically no separation was observed. In the case of single chiral enantiomer separation, the rejection of D-leucine is 32%, while that of L-leucine is only 3%. (FIG. 33). For racemic separation, the rejection of D-Leucine is 31% compared to 17% rejection for L-Leucine (FIG. 34). For Tryptophan, which is the tested molecule with size closest to the membrane cut-off, the results were even more encouraging. The membrane rejected around 24% of D-Tryptophan and near only 1% of L-Tryptophan, when testing a racemic mixture. These results indicate the perspective application of the membrane for superior chiral separation. The chiral selectivity of this membrane is assumed to be derived from the asymmetric environment of trianglamine for guest molecules through interactions such as hydrogen bonding, π-π stacking, and CH-π interactions.

### Molecular Simulations

Molecular simulations: Molecular modelling of trianglamine was constructed by referring to the single crystal structure. Protons of amine groups were omitted due to amide reaction during membrane formation. Molecular electrostatic potential (EPS) was mapped with the Gaussian 09 software package by density functional theory (DFT) calculations at B3LYP/6-31G level.

Models of monomer molecules were constructed and described with polymer-consistent force field (PCFF). 20 trianglamine molecules and 60 TPC molecules were packed in a cubic cell with dimension of 65 Angstrom, at low density of 0.4 g/cm³. For modeling the membrane prepared from trianglamine fragments, 60 linear molecules and 60 TPC molecules were packed in a cubic cell with dimension of 48.8 Angstrom. The chlorines in TPC molecules and the amino hydrogens in trianglamine molecules were removed. Carbons of carbonyls in TPC molecules and nitrogens in trianglamine molecules were marked with a tag, then polymerization step was performed between tagged carbons and nitrogens within a cutoff of 6 Angstrom, with energy minimization and MD steps to adjust molecules. Polymatic was used in generating amorphous polymer models and polymerization. The polymerized molecule was performed with a 21-step equilibrium. Unreacted ends of carbonyls and amine are restored to chlorines and hydrogens. LAMMPS is used in both MD step of polymerization and equilibration. Material Studio is used to analyze accessible surface, with a probe of 1 Å radius. Zeo++ is used to analyze voids, including void space, pore size distribution and the interconnectivity of void space, when probe radii are 0.85 Å, 1.2 Å, and 1.55 Å.

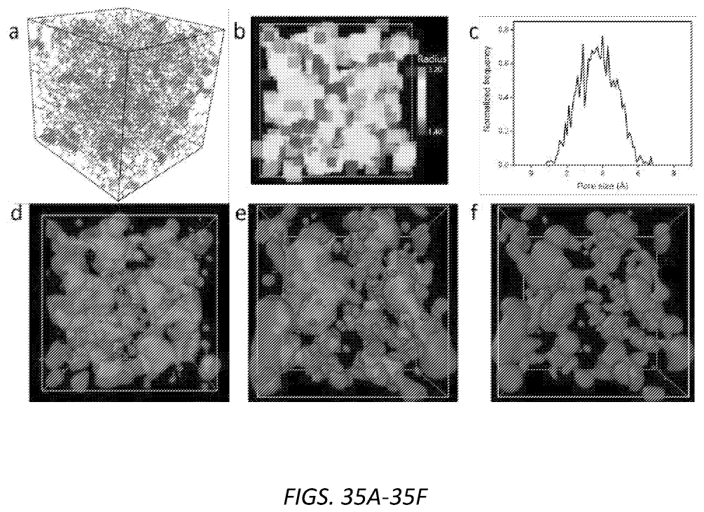

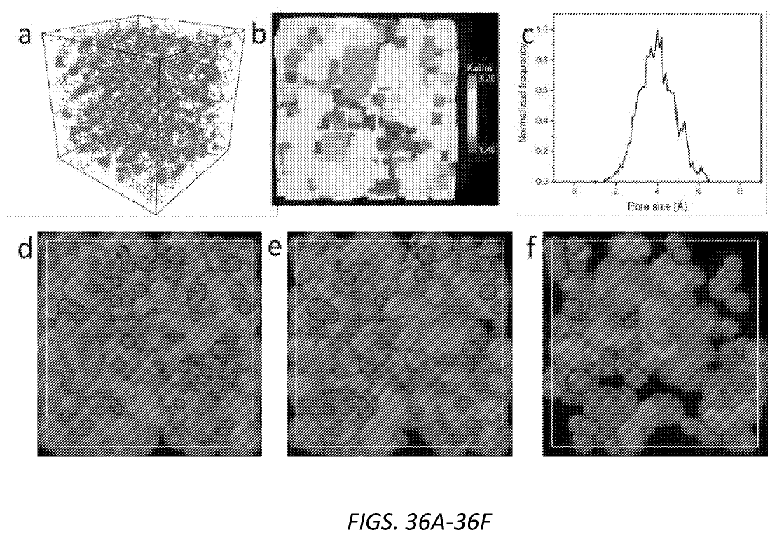

Molecular modeling of MPCM. To better understand and correlate the performance of the MPCM with the microstructure and free voids for permeation, a molecular simulation was performed. A realistic structural model was generated using the Polymatic program and the corresponding properties were analyzed. The polymeric film was considered amorphous. Details of the simulations are given in the Supplementary Information and the results are shown in FIGS. 35A-35F and FIGS. 36A-36F. The model representation for MPCM in FIG. 35A shows the structure of the crosslinked trianglamine synthesized in this work as a distinct rigid network with density of 1.163 g/cm³. By inserting theoretical probes of 1 Angstrom radius, the highlighted blue areas in FIG. 35A resulted, indicating a large fraction of interconnected free volume in the MPCM, accessible to the probes. FIG. 35B represents the distribution of voids with difference sizes (scale from 1.4 to 3.2 Å), each color corresponding to the largest probe radius that could be inserted. A simple plot of the voids size distribution can be easily derived from the simulation results, revealing that the most frequently present voids have an average size of 3.8 Å (FIG. 35C). The fraction of voids of different sizes that are interconnected, probes with different radii were inserted: 0.85 Å, 1.2 Å, and 1.55 Å, respectively. When the smallest probe with radius of 0.85 Å is inserted, the voids are highly interconnected (green) and the nanofilm has high porosity, indicating that small molecules would easily permeate through the membrane selective layer. As the probe radius increases, the fraction of interconnected voids decreases. When a theoretical probe radius of 1.55 Å is used, disconnected voids (red) fully dominate. This means that although a significant fraction of voids radius 1.55 Å or larger might be present in the selective layer, they would not contribute to the free diffusion of molecules of this size. The simulation can be interpreted as being exclusively related to the diffusivity of the crosslinked trianglamine layer and how it contributes to enhancing the transport of small molecules over larger ones, promoting a large size-selectivity. The simulation does not consider thermodynamic interactions between the permeant molecules and the membrane, which could potentially contribute to the solubility and overall permeance or could even partially swell the membrane, altering the absolute sizes of cavities and pores. Nevertheless, the simulation reveals the high free volume and porosity of the MPCM, proving the significance of the macrocycle building blocks in creating permanent interconnected nanoporosity within the membranes for the diffusivity of permeants.

The modelling of the membrane prepared from TPC and trianglamine fragments was also conducted to verify the importance of the macrocycle architecture. The arrangement of the chemical backbone in FIG. 36A is similar to that in FIG. 35A, but the fraction of void accommodating probes of 1 Å is clearly larger. FIG. 36B indicated a pore size distribution similar to the MPCM membrane. What is most interesting is the difference in interconnectivity of pores, comparing the two kinds of membranes. In opposite of what is observed for trianglamine membranes, the interconnectivity does not change much with the probe size in FIGS. 36D-36F. The MPCM membrane is highly selective, with the interconnectivity of pores promoting only the transport of molecules smaller than a specific size. The membrane prepared from trianglamine fragments is purely formed by physical entanglement, not crosslinked and the interconnectivity of pores accessible for permeation are less size-dependent. This might be a reason for the poorer selectivity of the fragment-based membrane compared to the trianglamine membrane. It rejects only 20% of congo red, while the trianglamine membrane is able to reject more than 90% of even smaller molecules.

### Materials and Methods

Materials: Methanol, ethanol, acetone, hexane and tetrahydrofuran (THF) were purchased from VWR Chemicals. Toluene and isopropanol (IPA) were procured from Sigma-Aldrich. Terephthaloyl chloride (TPC) was procured from TCI chemistry. All chemicals were used as received without further purification. The porous Anonic Alumina Oxide support (AAO) (Anodisc tm25, pore size 0.02 m) was obtained from GE Healthcare Life Sciences. The porous PAN membrane was obtained from GMT GmbH. Deionized (DI) water (>18 MΩcm) used in all experiments was filtered through a Millipore Milli-Q water purification system.

Preparation of Aqueous Phase Including Trianglamine: Trianglamine was synthesized for use as the trianglamine macrocycle according to known methods. To prepare the aqueous phase solution, trianglamine was first added to water (about 10 ml) and sonicated to form turbid dispersion, followed by the addition of HCl (0.1 M) dropwise until the pH was about 6.6 and the solution became almost transparent. After filtration with a syringe filter (0.22 m of pore size), the clear solution was stored in a refrigerator for use and characterization.

Membrane Preparation: Thin-film composite membranes were fabricated on PAN ultrafiltration membrane (GMT GmbH, Rheinfelden, Germany) supports via interfacial polymerization. First, supports with the proper area were fixed with PTFE frames. About 12 mL of aqueous solution (2% or 1% w/w) was added and the supports were impregnated for about 10 min. Excess solution was removed and the surfaces of the supports were wiped with a rubber roller. Then the saturated supports were immersed in the TPC solution in hexane with 0.1% w/v concentration (unless otherwise stated) for a certain time, which resulted in the formation of a hyper-crosslinked MPCM nanofilm on top of the PAN supports. Finally, the resulting membranes surfaces were rinsed with 20 mL of hexane to remove unreacted TPC. All membrane preparation experiments were carried out at about room temperature and a relative humidity of about 60%.

Freestanding MPCM nanofilms were formed at the free interface between aqueous and organic solution using the same parameters as that of thin film composite membranes. After a certain period of time, the generated nanofilms can be deposited on silica wafers or alumina supports following the process depicted in FIGS. 3A-3G.

Instrumentation: Attenuated Total Reflection-Fourier transform infrared (ATR-FTIR) spectra were obtained on a Nicolet iS10 spectrometer with 16 scans and resolution of 4 cm¹. To get sufficient amount of material for characterization, the membrane was continuously isolated from the free interface between the aqueous and organic solutions by using a silica wafer as a collector. Then the collected membrane material was washed with water and ethanol for one hour, respectively, and dried at 40° C. under vacuum. X-ray photoelectron spectroscopy (XPS) was performed on an Axis-Ultra DLD spectrometer using Al Kα radiation (hv=1486.6 eV) under the base pressure of 3×10⁻⁹ mbar. The binding energy data were calibrated in terms of the Cis signal of aromatic carbon 284.5 eV used as a reference. Scanning electron microscopy (SEM) images were taken from a Zeiss Merlin field-emission scanning electron microscope at 3 kV and 100 pA with a working distance of 3 mm. High-resolution mode and Inlense detector were adopted. The samples were fixed on the specimen holders and then sputtered with 3 nm iridium in a Quorum Q150T to ensure conductivity. For cross-sectional SEM imaging, the membrane sample was cryogenically fractured in liquid nitrogen. Atomic force microscopy (AFM) images were obtained on a Dimension ICON scanning probe microscope under tapping mode. Surface morphology images and height profiles were obtained from silica wafer supported film samples at room temperature using FESPA etched silicon probes (spring constant=2.8 N/m) with scan rate of 1 Hz. Transmission Electron Microscope (TEM) images were collected on FEI Titan CT microscope operating at 300 kV. The samples were prepared as follows: the membranes were first immersed in an epoxy resin and cured at 65° C., then thin sections having approximately 100 nm thickness were cut with Ultramicrotome Leica UC7 and collected on 300 mesh copper grids for TEM imaging. Wide-angle X-ray diffraction (XRD) patterns were collected on a Bruker D8 Advance with Cu KR radiation (λ=1.5406 Å). The Scan range is from 5 to 90 degrees with scan speed of 5 degree/min. Thermogravimetric analysis (TGA) was performed on the TA-Q500 with a temperature ramp of 5° C. min⁻¹ and a 20 ml/min nitrogen flow rate. Water contact angle (CA) was measured on a Kruss drop shaper analyzer DSA100 with a monochrome interline CCD camera. For each experiment, 5 μL of water was injected and contacted with the sample surface, and the water contact angle was automatically calculated with the fitting method of Elipse (Tangent-1). NanoDrop UV-vis spectrophotometer was used to determine the concentration of feed and filtrate dye solution, using quartz cuvettes for sampling.

1. A method of fabricating a molecularly porous cross-linked membrane comprising reacting a aqueous phase containing an amine macrocycle and an organic phase containing an acyl chloride to induce interfacial polymerization.

2. The method of claim 1, wherein the amine macrocycle is a trianglamine.

3. The method of claim 1, wherein the acyl chloride is terephthaloyl chloride.

4. The method of claim 3, wherein the terephthaloyl chloride is present at a concentration of 0.0125% w/v to 0.1% w/v in the organic phase.

5. The method of claim 1, further comprising inducing interfacial polymerization on a polyacrylonitrile membrane support.

6-8. (canceled)

9. The method of claim 7, wherein the method further comprises depositing the formed membrane on a silica wafer or alumina support.

10. The method of claim 1, wherein the amine macrocycle is present at a concentration of 1-2 wt % in the aqueous phase.

11. A polyamide molecularly porous cross-linked membrane comprising a crosslinked network of amine macrocycle monomers.

12. The membrane of claim 11, wherein the amine macrocycle monomers are trianglamine having the following structure:

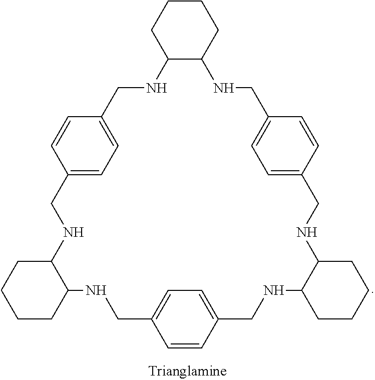 [SMILES: c1cc2ccc1CNC1CCCCC1NCc1ccc(cc1)CNC1CCCCC1NCc1ccc(cc1)CNC1CCCCC1NC2]

13. The membrane of claim 12, wherein each trianglamine is covalently linked with four trianglamines.

14. The membrane of claim 11, wherein the crosslinks are formed by reaction of a acyl chloride with an amine group of the macrocycle ring.

15. The membrane of claim 11, wherein the membrane is less than 10 nm thick.

16. A molecularly porous cross-linked membrane comprising:
a crosslinked network of reactive macrocycle monomers having at least two amine groups in the ring, wherein at least two reactive macrocycle monomers are crosslinked to each other via a polyfunctional acyl halide.

17. The membrane of claim 16, wherein at least one reactive macrocycle monomer is a trianglamine of formula I: 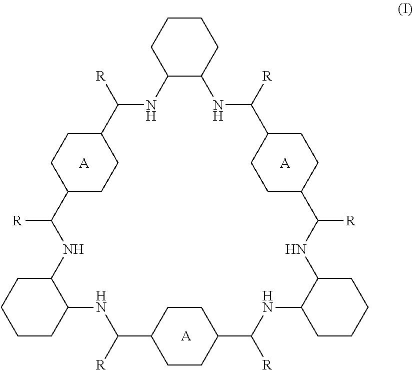
wherein:
each A is an aromatic moiety independently selected from the group consisting of substituted or unsubstituted phenyl, substituted or unsubstituted biphenyl, substituted or unsubstituted triphenyl, substituted or unsubstituted terphenyl, substituted or unsubstituted diphenyl ether, substituted or unsubstituted naphthalene, and substituted or unsubstituted anthracene; and
each R is independently nothing, a hydroxyl, an alkyl, or an alkoxy, with the proviso that when R is nothing the carbon atom to which the R group would be attached is bonded to at least two hydrogens.

18. The membrane according to claim 17, wherein each A is independently selected from the aromatic moieties of Formula IIA-IID: 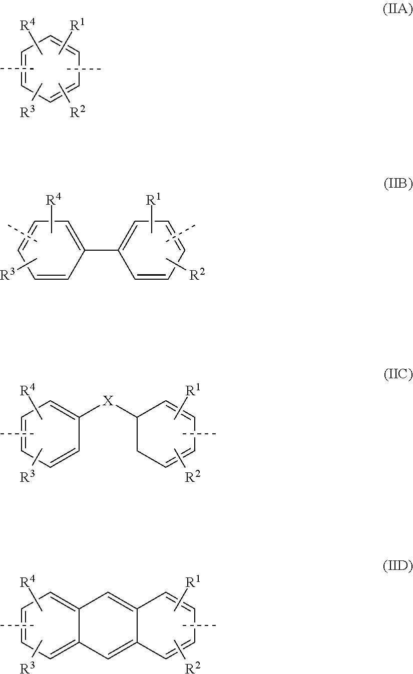
wherein: [symbol]
is a point of attachment or nothing;
X is a C, N, S, or O;
R¹, R², R³, and R⁴ are independently a hydrogen, a halogen, a hydroxyl, a linear or branched alkyl, an alkoxy, an aryloxy, or an aralkoxy.

19. The membrane of claim 17, wherein the trianglamine is a reaction product of a diaminocycloalkyl compound and an aromatic dialdehyde compound.

20. The membrane of claim 16, wherein the polyfunctional acyl halide has at least two acyl halide groups.

21. The membrane of claim 20, wherein the polyfunctional acyl halide is selected from the group consisting of trimesic acid chloride, terephthalic acid chloride, isophthalic acid chloride, biphenyl dicarboxylic acid chloride, and naphthalene dicarboxylic acid dichloride cyclopropane tricarboxylic acid chloride, cyclobutane tetracarboxylic acid chloride, cyclopentane tricarboxylic acid chloride, cyclopentane tetracarboxylic acid chloride, cyclohexane tricarboxylic acid chloride, tetrahydrofuran tetracarboxylic acid chloride, cyclopentane dicarboxylic acid chloride, cyclobutane dicarboxylic acid chloride, cyclohexane dicarboxylic acid chloride, and tetrahydrofuran dicarboxylic acid chloride, or a combination thereof.

22. The membrane of claim 16, wherein a percentage of reacted amine groups of the reactive macrocycles is at least 50%.

23. The membrane of claim 16, wherein the membrane includes reactive macrocycles having from 2-5 reacted amine groups per macrocycle.

24-38. (canceled)
